(19) United States
(12) Patent Application Publication
(10) Pub. No.: US 2024/0259719 A1
(43) Pub. Date: Aug. 1, 2024

(54) VEHICLE CAGE TOWER SPEAKER AND MOUNTING APPARATUS

(71) Applicant: Grace Digital, Inc., San Diego, CA (US)

(72) Inventors: Greg William Fadul, San Diego, CA (US); James D. Palmer, San Diego, CA (US)

(21) Appl. No.: 18/210,642

(22) Filed: Jun. 15, 2023

Related U.S. Application Data
(63) Continuation-in-part of application No. 18/102,581, filed on Jan. 27, 2023.

(51) Int. Cl. H04R 1/02

(52) U.S. Cl. CPC H04R 1/026; H04R 2201/025

(57) ABSTRACT

A mounting system including inner and outer structures, a mount fixture, a securing plate, and a securing key is disclosed. The inner structure includes an annulus encircled by an engagement groove. The outer structure includes an annular surface having a grooved slot. The annular surface contours about the inner structure annulus. The mount fixture includes a passage and a receiving opening. The securing plate abuts the mount fixture and includes a receiving slot having locking and unlocked portions. The securing key includes a prong, a stopper prong, a stopping structure, and a locking groove. The prong extends through the passage and the slot unlocked portion, while also passing along the grooved slot and abutting the engagement groove. The securing key stopping structure abuts the mount fixture and the locking groove fits within the locking portion. The stopper prong extends into the receiving opening and abuts the engagement groove.

### CROSS-REFERENCES

This patent application is a continuation-in-part of non-provisional patent application Ser. No. 18/102,581 entitled VEHICLE CAGE TOWER SPEAKER AND MOUNTING APPARATUS filed on Feb. 10, 2020; the above patent application is hereby incorporated by reference in this patent application.

### FIELD

The present disclosure relates to cage tower speaker systems and mounting apparatus of such. More particularly, the present disclosure relates to a cage tower speaker and quick release mounting apparatus adapted for outdoor use mounted on a vehicle.

### BACKGROUND

A variety of systems for housing, amplifying, mounting, and protecting one or more speakers have been developed. Initially, these systems were designed specifically for indoor use and maximizing the user's experience in a home setting. In particular, the cabinets or other structures containing speakers were composed of wood and/or cardboard, and organized to emit and disperse sound to reflect off of nearby walls and ceilings back toward a listener. The advent of speaker systems constructed from plastic and/or metal facilitated portable systems suitable for certain outdoor uses.

Many consumers wish to utilize audio or other multimedia devices while engaging in recreational activities such as power sports, boating, off-roading, etc. Indeed, portable wireless speakers are increasingly used in varied indoor and outdoor environments including boating, off-road driving, and other rugged and potentially weather and water prone environments. Available media players typically draw power from a vehicle battery, requiring conscientious management of battery loading and charge.

However, successfully adapting speaker systems for attachment to various recreational land vehicles, particularly off-road vehicles such as an ATV, dune buggies and similar land vehicles, as well as marine vessels such as ski boats, off-shore recreational fishing boats, party barges and similar watercraft, requires overcoming various problems unique to these land vehicles and watercraft. Sound systems for such vehicles must (1) be impact resistant; (2) provide durable attachment to the vehicle; (3) this durable attachment must also allow for quick and simple adjustments to the position and/or directionality of the speakers to accommodate changes in the listening environment; (4) this durable attachment should also provide a quick and manageable release mechanism to safeguard the mounted speaker system from theft; (5) this quick and manageable release mechanism should prevent the speaker system from falling during removal; (6) provide sufficient audio volume without significantly impacting a vehicle operator's visibility; and (7) protect the electrical components of the speakers from dirt, dust, mud, and/or water.

U.S. Pat. No. 5,191,177 was an early attempt to provide a stable, convenient speaker system for an automobile requiring minimal alteration to the vehicle. This speaker system's convenience relied on the presence of a flat surface within the vehicle for the system to rest upon. Since this system merely rested upon a flat surface within the vehicle, it was limited to on-road trucks and cars, but not suitable to off-road vehicles or watercraft that travel over bumpy terrain such as dusty/muddy trails and choppy water. Such off-road and over-water travel submit sound systems to vigorous physical shaking and jolting requiring very secure attachment to the vehicle or watercraft, as well as construction that could withstand significant mechanical impact. Additionally, this speaker system was constructed from cardboard, further limiting its use to an enclosed interior location of a vehicle as it would not withstand prolonged or repeated exposure to dirt, dust, mud, rain, and/or splashed water, such as from waves, wakes or wet passengers.

U.S. Patent Publication 2008/0141924 presented an alternative speaker assembly especially adapted for use on watercraft. This system solved the problem of water exposure and impact durability by mounting speakers within retractable housings. However, these housings require substantial modification of the watercraft and provide only directional sound aimed rearward toward individuals towed behind the watercraft.

U.S. Pat. No. 8,948,437 improved upon the speaker systems for watercraft by providing vertically oriented sound rods of a stainless steel construction that provide 360º sound in an approximately horizontal plane. However, the mounting system employed is limited to watercraft, and particularly watercraft with existing fishing rod holders that can receive the mounting pole of the sound rod.

U.S. Pat. No. 9,469,254 provided a more versatile mounted speaker system for off-road vehicles, ATVs, UTVs, watercraft, and motorcycles that employs an L-shaped mounting bracket to attach an array of speakers to such vehicles. The L-shaped mounting bracket enables rotation of the speaker array 360° about the plane in which the array is mounted. However, the orientation of the speaker array limits sound dispersion from any given orientation (i.e., rotational position) of the array to a single direction.

U.S. Pat. No. 8,568,162 described a clamp assembly for mounting and suspending loudspeaker assemblies that comprised annular structures that fit within one another. An outer annular structure includes slotted holes that receive prongs from a fork, while an inner annular structure includes a groove that receives the prongs as well, such that the annular structures cannot disengage while the prongs are inserted therein. The configuration of the annular structures allows them to rotate in a plane parallel to the prongs while the fork prongs are engaged. The fork may also include a set screw that locks the annular structures in place, preventing their rotation relative to one another by engaging with the groove of the inner annular structure. However, the clamp assembly requires a tool to fully engage the set screw and lock the annular structures in place, as well as to disengage the set screw. Further, in the absence of the set screw no safeguards exist to prevent either the fork or the loudspeaker from falling.

Although such prior art devices have addressed some of the prior art problems, there remains a need in the industry for a durable speaker mounting system that provides directional adjustable sound and readily releases from a mounted position, thereby reducing or eliminating prior art problems.

### SUMMARY

A cage tower speaker mounting system and method of use are described herein. In one embodiment, the cage tower speaker mounting system includes an inner annular structure, an outer annular structure, a base mount fixture, a securing plate, and a securing key. The inner annular structure includes a central annulus and an engagement groove encircling the central annulus. The outer annular structure includes an annular surface having a grooved slot. The annular surface contours about an outer diameter of the central annulus of the inner annular structure when the central annulus is inserted into the outer annular structure. The base mount fixture is affixed to one of the inner annular structure and the outer annular structure and includes at least one passage there through and a receiving opening. The securing plate abuts the base mount fixture and includes at least one receiving slot having a locking portion and an unlocked portion. The securing key includes at least one prong, a stopper prong, a stopping structure, and a locking groove. The at least one prong of the securing key extends through the at least one passage of the of the base mount fixture and the unlocked portion of the at least one receiving slot on the securing plate, while also passing along the grooved slot in the annular surface of the outer annular structure and abutting the engagement groove of the central annulus of the inner annular structure. The stopping structure of the securing key abuts the base mount fixture and the locking groove of the at least one prong of the securing key fits within the locking portion of the at least one receiving slot on the securing plate. The stopper prong extends into the receiving opening and abuts the engagement groove.

In one embodiment, the method of operating the cage tower speaker mounting system includes inserting a central annulus of an inner annular structure into a central annular cavity of an outer annular structure. The central annulus of the inner annular structure includes an engagement groove. The central annular cavity of the outer annular structure surrounds the central annulus of the inner annular structure. The outer annular structure includes an annular surface having a grooved slot. The inner annular structure includes an engagement groove encircling the central annulus. The method of operation proceeds by inserting at least one prong of a securing key through at least one passage of a base mount fixture, along the grooved slot of the annular surface, and through an unlocked portion of at least one receiving slot of a securing plate so that the at least one prong of the securing key abuts the engagement groove of the central annulus. The stopper prong is inserted into a receiving opening in the base mount fixture so that the stopper prong abuts the engagement groove.

### FIGURES

The present invention will be more fully understood by reference to the following drawings which are presented for illustrative, not limiting, purposes.

FIG. 1 shows an isometric view of an illustrative cage tower speaker.

FIG. 2 shows a front view of the illustrative cage tower speaker.

FIG. 3 shows a top view of the illustrative cage tower speaker.

FIG. 4 shows a bottom view of the illustrative cage tower speaker.

FIG. 5 shows a side view of the illustrative cage tower speaker.

FIG. 6 shows a rear view of the illustrative cage tower speaker.

FIG. 7A shows a view of the uncovered backside of the illustrative cage tower speaker.

FIG. 7B shows a view of an illustrative removable rechargeable battery.

FIG. 7C shows a view of the rear cover of the illustrative cage tower speaker in isolation.

FIG. 8 shows a cutaway view of the interior of the illustrative cage tower speaker.

FIGS. 9A and 9B show a releasable, lockable mounting clamp for cage tower speaker systems.

FIG. 10 shows an exploded view of the releasable, lockable mounting clamp.

FIG. 11 shows a cross-sectional view of the releasable, lockable mounting clamp.

FIG. 12 shows an isometric view of a securing fork with a stopper prong.

FIG. 13 shows an exploded view of a securing fork with a stopper prong, a corresponding base mount, a prong stopper, and an outer annular structure.

FIG. 14 shows a cross-sectional view along a horizontal plane of the base mount with a securing fork and set screw assembly fully inserted therein.

FIG. 15 shows an isometric view of a releasable, lockable mounting clamp with a securing fork having a stopper prong inserted therein.

FIG. 16 shows a bottom view of the releasable, lockable mounting clamp with a securing fork having a stopper prong inserted therein.

FIGS. 17A and 17B show a securing plate.

FIGS. 18A and 18B show an inner annular structure of an engagement mechanism.

FIGS. 19A-C show an outer annular structure of the engagement mechanism.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the apparatus and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims.

In various embodiments, the cage tower speaker system disclosed herein may include one or more cage tower speaker unit. In embodiments where the cage tower speaker system comprises multiple speaker units, one of the cage tower speaker units may be a driving speaker unit that includes a battery and amplifier, while the other cage tower speaker units are dummy speakers that lack their own battery, an amplifier, or a combination thereof. In these embodiments, the driving speaker unit provides both power and audio input to the dummy speaker unit(s).

In various embodiments, the one or more cage tower speaker unit may include a removable rechargeable battery within an outer cage tower speaker housing. The outer housing of each cage tower speaker can further include waterproof membranes coupled to the outer housing that serve the dual purpose of releasing a portion of the back pressure generated by the cage tower speaker, as well as, equalizing the internal pressure of the outer housing with the external pressure of the ambient air surrounding the outer housing, while sealing the interior spaces of the outer housing from the outdoor conditions in which the cage tower speaker system operates.

In operation, the waterproof membranes on the outer housing further maintain the structural integrity of the cage tower speaker, its components, and the sound quality emitted therefrom by preventing pressure differentials accumulating between the interior of the cage tower speaker and the exterior of the cage tower speaker due to environmental conditions or back pressures emitted from the cage tower speaker.

In some embodiments, each cage tower speaker unit is removably secured to a vehicle with a mounting bracket having a quick-release engagement mechanism including a pronged securing key, a set screw, and securing plate. The securing plate and pronged securing key of the quick-release engagement mechanism operate to prevent the quick-release engagement mechanism from fully disassembling and allowing the cage tower speaker to fall from its position even when the set screw is removed. The securing plate achieves this operation by receiving one or more prongs of the securing key in corresponding openings and slotting over grooves in each of the prongs, so that the closed end of the fork and the securing plate are situated on opposing sides of the engagement mechanism and the fork cannot readily be removed from the engagement mechanism.

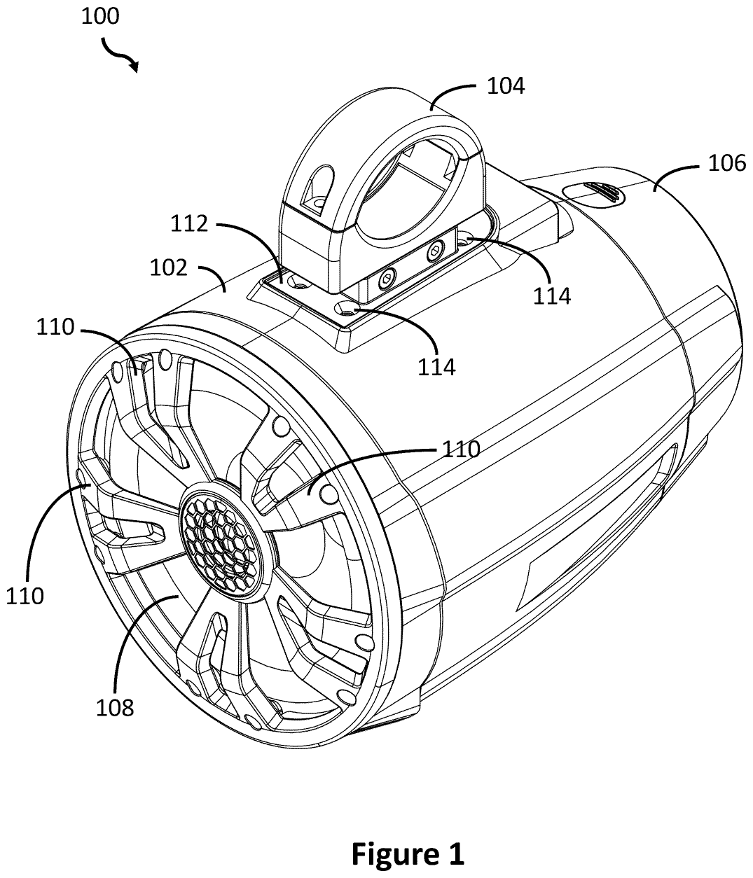

Referring to FIG. 1 there is shown an isometric view of an illustrative cage tower speaker 100. The illustrative cage tower speaker includes an outer housing 102, a mounting bracket 104, a rear cover 106, a speaker driver assembly 108, and a speaker grill 110. The outer housing 102 is hollow and forms an interior cavity space (not shown) that receives the speaker driver assembly 108. The interior cavity space extends from a frontal opening (not shown) that receives the speaker driver assembly 108 to an internal barrier wall (not shown). The outer housing 102 includes an exterior surface that extends from the speaker grill 110 to the rear cover 106. The outer housing 102 also includes a mounting inlay 112 on the exterior surface that receives the mounting bracket 104.

The speaker grill 110 covers the speaker driver assembly 108 and is coupled to the outer housing 102. In some embodiments, the speaker grill 110 is coupled to the outer housing 102 with threading on the speaker grill 110 that is complimentary to threading on one of the frontal opening (not shown) and the exterior surface of the outer housing 102. In some embodiments, the speaker grill 110 is coupled to the outer housing 102 with one or more fasteners, such as screws, nails, pins, snaps, or rivets.

In some embodiments, the outer housing 102 is of a durable waterproof construction, such as metal (e.g., aluminum, titanium, steel, stainless steel), a metal alloy, a composite, plastic, carbon fiber, or another equivalently rigid material.

Although the illustrative speaker grill 110 is a combination of a traditional metal mesh and ribbed frame, the speaker grill 110 may be composed of any suitable material, such as metal (e.g., aluminum, titanium, steel, stainless steel), a metal alloy, a composite, plastic, carbon fiber, and a combination thereof. In some embodiments, the mesh portion of the speaker grill 110 may be formed from any suitable patterning other than the simple repeating array of offset circular openings, such as slots, asymmetric patterning, or patterning resembling images. In some embodiments, the speaker grill 110 comprises only a ribbed frame. In some embodiments, the speaker grill 110 comprises only a mesh spanning the entirety of the frontal opening (not shown) and/or speaker driver assembly 108. In some embodiments, the speaker grill 110 comprises only a grill mesh.

In some embodiments, the speaker driver assembly 108 includes a clear plastic speaker driver cone and an LED light that is behind the driver cone and within the outer housing 102 interior cavity space. The clear plastic speaker driver cone transmits light from the LED outward away from the cage tower speaker 100. In these embodiments, the speaker driver assembly 108, the speaker driver cone, the outer housing 102, the speaker grill, and any combination thereof form a waterproof to protect the speaker components from water damage.

The illustrative rear cover 106 is of a durable waterproof construction, such as metal, (e.g., aluminum, titanium, steel, stainless steel), a metal alloy, a composite, plastic, carbon fiber, or another equivalently rigid material. In some embodiments, the rear cover 106 encloses a rear cavity (not shown) that receives one or more batteries (not shown). In some embodiments, the rear cover 106 is removably affixed to the outer housing 102 by means of one or more screws, pins, fasteners, or threading on the rear cover 106 that mates with threading on the rear of the outer housing 102. In the embodiment where the rear cover 106 is removably affixed to the outer housing 102 by threading, the rear cover threading intermeshes with threading surrounding the rear cavity (not shown) of the outer housing 102.

In some embodiments, the mounting inlay 112 includes a plurality of receiver openings 114 that couple with fasteners that affix the mounting bracket 104 to the outer housing 102. In some embodiments, the mounting inlay 112 is formed from metal (e.g., aluminum, titanium, steel, stainless steel), a metal alloy, a composite, a plastic, carbon fiber, or other suitably durable material that is capable of supporting the weight of the cage tower speaker 100. In some embodiments, the mounting inlay 112 may be affixed to the outer housing 102 with adhesive, waterproof foam, and/or internal fasteners such as screws, rivets, or pins. The combination of adhesive, waterproof foam, and internal fasteners seal the joint between the outer housing 102 and the mounting inlay 112.

In some embodiments, the receiver openings 114 include collars that couple with pins, flanged or otherwise. In some embodiments, the receiver openings 114 include internal threading that intermesh with screws, threaded bolts, or other fasteners. In some embodiments, the threaded bolts pass through unthreaded clearance openings in the mounting bracket 104 and extend into the female threaded receiver openings 114 of the mounting inlay 112 to immovably affix the mounting bracket 104 to the outer housing 102. In some embodiments, the plurality of receiver openings 114 are arranged in rows, circles, and other geometric patterns that allow the mounting bracket 104 to be attached in multiple locations along the length of the mounting bracket 104 and multiple orientations along that length, such as rotated at a right angle or any other angle to the length of the outer housing 102. In the illustrative embodiment, the mounting bracket 104 is affixed to the outer housing at the center position of the mounting inlay 112 and oriented parallel to the length of the outer housing 102.

In the illustrative embodiment, the mounting inlay 112 is located on a top portion of the outer housing 102. In some embodiments, the mounting inlay 112 is located on a side portion of the outer housing 102.

The illustrative mounting bracket 104 is a two-piece ring bracket that can be attached to a pipe, pole, or other cylindrical structure. In some embodiments, the mounting bracket 104 is an L-shaped bracket having attachment points located on one arm of the L-bracket that enables the arm to be removably connected to the mounting inlay 112 and the outer housing 102. In some embodiments, the L-shaped bracket further includes attachment points located on a second arm of the L-bracket that enables the second arm to be removably connected to a vehicle. In some embodiments, the L-shaped bracket further includes a pivot point located on the other arm of the L-shaped bracket and provides an attachment point to a vehicle or mating bracket thereon. The combination of the L-shape and the pivot point allows a cage tower speaker 100 attached thereto to rotate about the pivot point 360º. The pivot point can receive a bolt, pin, or other rotatable fastener that extends through the pivot point and the mating bracket to allow the cage tower speaker 100 to rotate about the pivot point. In some embodiments, the mounting bracket 104 is an angle bracket.

In various embodiments, the speaker driver assembly 108 includes a woofer speaker. In various embodiments, the speaker driver assembly 108 includes a mid-range speaker. In various embodiments, the speaker driver assembly 108 is a tweeter speaker.

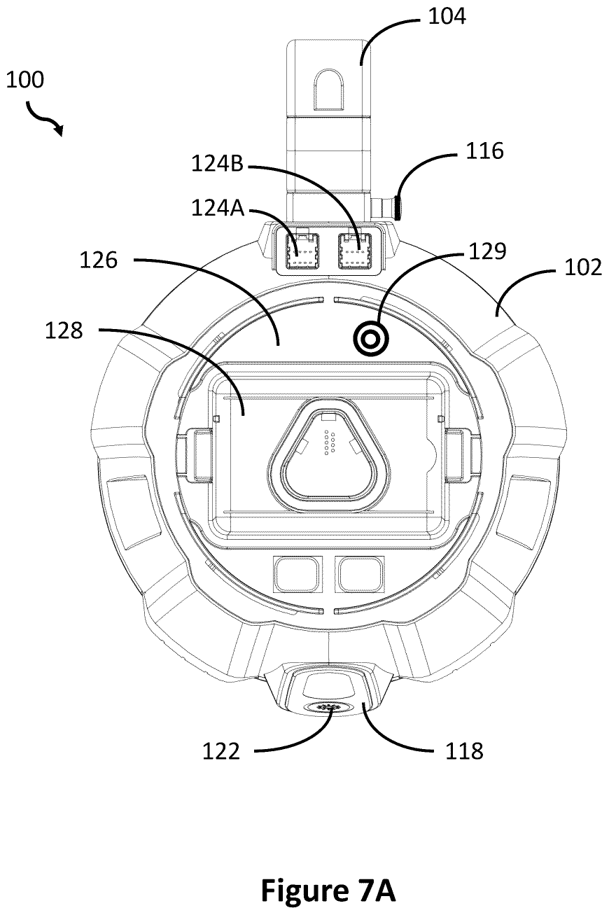

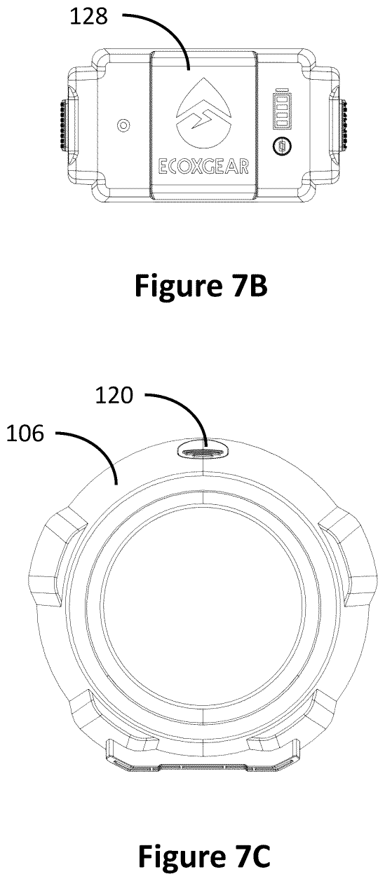

In some embodiments, the cage tower speaker 100 includes an integrated amplifier housed with the outer housing 102 of the cage tower speaker 100. In these embodiments, the amplifier is electrically coupled to the removable rechargeable battery 128 (shown in FIGS. 7A-C and 8).

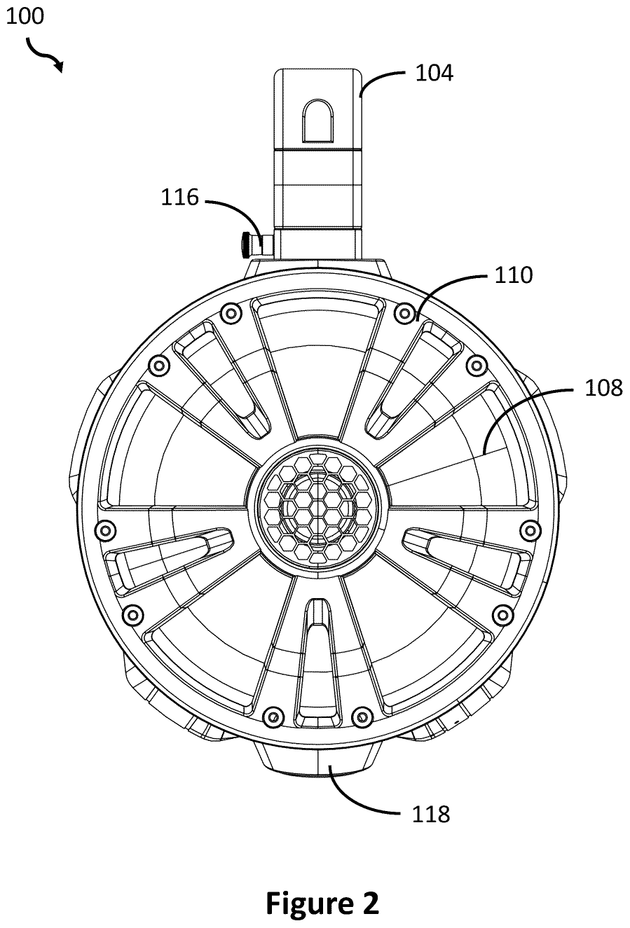

Referring now to FIG. 2, there is shown a front view of the cage tower speaker 100. This view shows the mounting bracket 104 end on, which includes a set screw 116. The set screw 116 may be loosened to quickly change the orientation of the mounting bracket 104 by allowing the outer housing 102 (and by extension the cage tower speaker itself) to rotate. The set screw 116 may then be tightened to secure the outer housing 102 in a new orientation.

This view also shows a control panel 118 end on, which includes a plurality of radios. In some embodiments, the plurality of radios include an FM radio. In some embodiments, the plurality of radios include a Bluetooth radio. In some embodiments, the plurality of radios include a Wi-Fi radio. In some embodiments, the control panel 118 includes an FM radio module. In some embodiments, the control panel 118 includes a Bluetooth module. In some embodiments, the control panel 118 includes a Wi-Fi module. In some embodiments, the control panel 118 includes one or more buttons (not shown) that may receive user input, i.e. be depressed by a user, and thereby operate or engage the various functions and capabilities of the cage tower speaker 100 and any associated dummy speaker (not shown). In some embodiments, the one or more buttons of the control panel 118 receive user input in order to control operation of the cage tower speaker 100, such as Bluetooth connectivity, speaker volume, sound balance, music controls, and lighting effects.

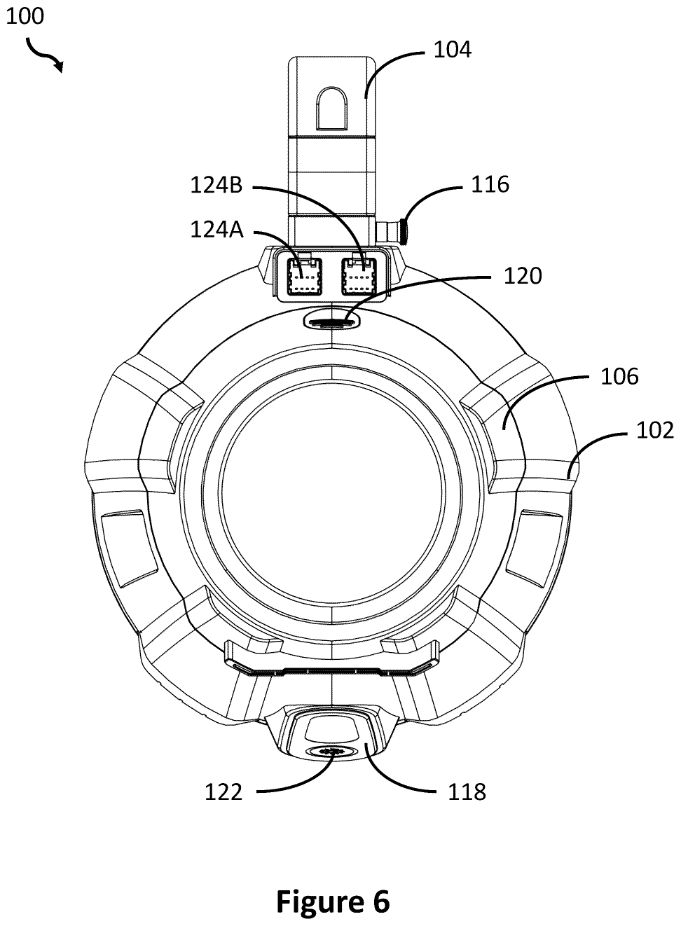

In some embodiments, the control panel 118 includes indicator lights 122 (shown in FIG. 6) that identify operation modes and functions of the cage tower speaker 100, i.e. whether the cage tower speaker 100 is receiving power, whether the battery has a charge, power on/off, receiving radio signal, receiving Wi-Fi signal, receiving Bluetooth signal, or playing music. The control panel 110 is communicatively coupled to the speaker driver assembly 108, as well as a power source, such as a battery or power from the vehicle to which it is mounted, a processor, a memory, a wireless communication module, auxiliary ports, and one or more LED lights embedded in the speaker driver assembly 108. Power from an external power source may be received through a power cable and delivered to the control panel 118, processor, memory, wireless communication module, LED lights, and speaker driver assembly(s) 118. As with the other electrically powered components of the cage tower speaker 100, the LED light(s) is electrically coupled to, controlled by, and operated from the control panel 118.

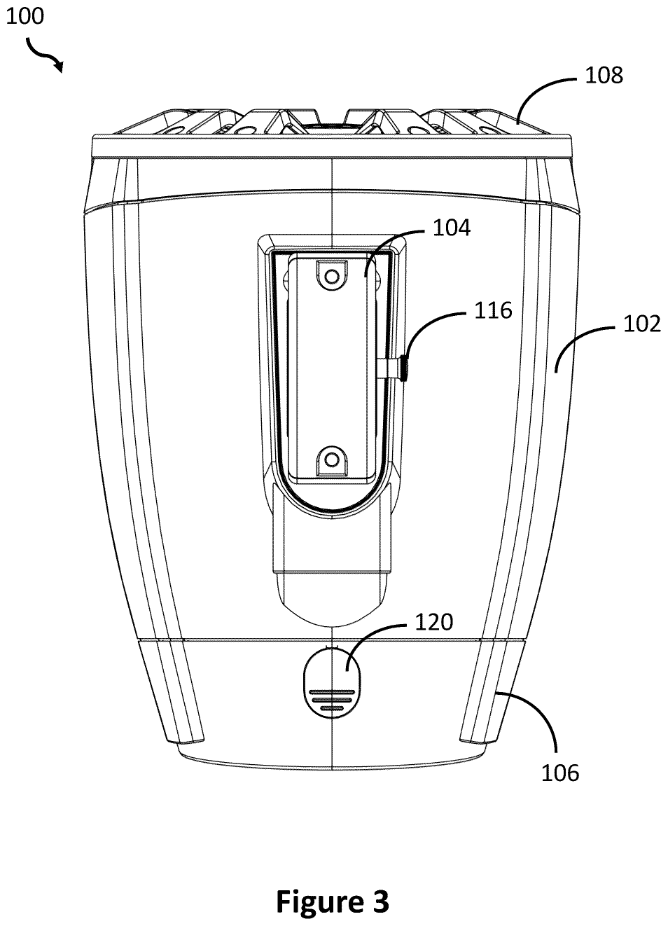

Referring now to FIG. 3, there is shown a top view of the illustrative cage tower speaker 100. This view shows the mounting bracket 104 aligned with the length of the outer housing 102 and locked in place by the set screw 116. This view also shows the speaker grill 108 in profile and depressor button 120 that detaches the rear cover 106 from the outer housing 102. The depressor button 120 may activate or disengage a clasp holding the rear cover 106 in place and affixed to the outer housing 102.

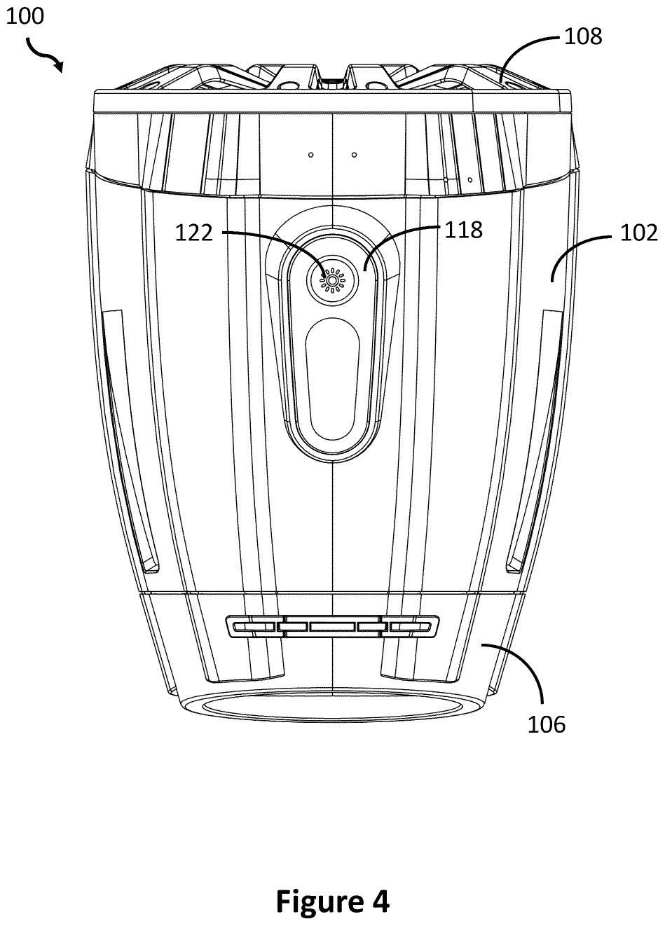

Referring now to FIG. 4, there is shown a bottom view of the illustrative cage tower speaker 100. This view again displays the speaker grill 108 in profile, while also displaying the rear cover 106 in profile. This view further displays the control panel 118 and an indicator light 122 on the control panel 118. In some embodiments, the indicator light 122 may indicate that the cage tower speaker 100 is receiving power, such as from an outdoor vehicle, watercraft, or similar vehicle. In some embodiments, the indicator light 122 may indicate that the cage tower speaker 100 is communicatively coupled to a dummy cage tower speaker, such as by Bluetooth. In some embodiments, the indicator light 122 may indicate that the cage tower speaker 100 is communicatively coupled to a user device, i.e., smartphone. In some embodiments, the indicator light 122 may indicate that the cage tower speaker 100 is communicatively coupled to a user device, such as by Bluetooth.

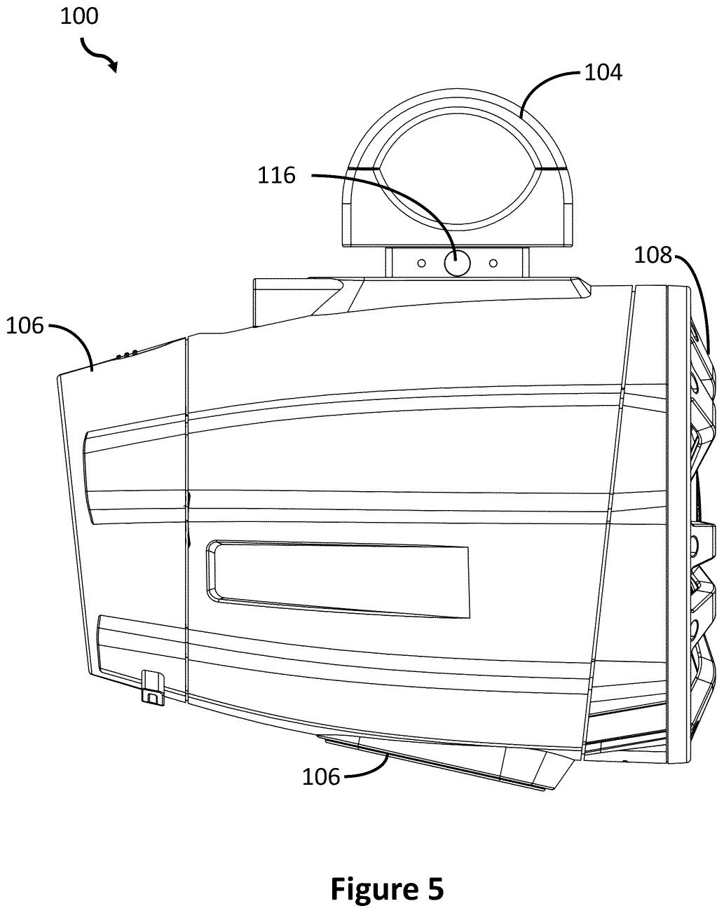

Referring now to FIG. 5, there is shown a side view of the cage tower speaker 100. This side view displays the illustrative two-piece ring mounting bracket 104 secured in a lengthwise orientation by the set screw 116. This side view also displays the speaker grill 108, the rear cover 106, and the control panel in profile.

Referring now to FIG. 6, there is shown a rear view of the cage tower speaker 100 with the rear cover 106 secured in place by a latching mechanism coupled to the depressor button 120. This view displays the conical shape of the illustrative rear cover 106, as well as the semi-conical shape of the outer housing 102 (demonstrated by the angled view of the control panel 118 and indicator light 122). This view further displays the mounting bracket 104 secured in a lengthwise orientation by the set screw 116. This view also displays one or more electrical ports 124A and 124B. In some embodiments, one or more of the electrical ports 124A and 124B communicatively couple the tower cage speaker 100 to a dummy speaker through an audio cable or auxiliary cable. In some embodiments, one or more of the electrical ports 124A and 124B communicatively couple the tower cage speaker 100 to an illustrative user's mobile device, such as a smartphone. In some embodiments, one or more of the electrical ports 124A and 124B electrically couple the tower cage speaker 100 to the dummy speaker, which provides power to the dummy speaker from the cage tower speaker 100 through a power cable. In some embodiments, one or more of the electrical ports 124A and 124B electrically couple the tower cage speaker 100 to a vehicle through a power cable, which provides power to the cage tower speaker 100 and/or one or more dummy speaker. In the illustrative embodiment, the one or more of the electrical ports 124A and 124B are each 8-pin connector ports.

In some embodiments, the cage tower speaker 100 further includes a power management module associated with control panel 118 that controls recharging operations. The control panel 118 may include one or more buttons 119 on the surface of the control panel 118. In some embodiments, the power management module recharges the removable rechargeable battery 128 when the cage tower speaker 100 is connected to external power, such as an outdoor vehicle or watercraft. In some embodiments, the power management module recharges the removable rechargeable battery 128 only when the cage tower speaker 100 is connected to a running engine of an outdoor vehicle or watercraft, in order to limit or prevent the possibility of drawing down all of the power in the outdoor vehicle or watercraft's battery, thereby killing the battery and stranding the operator. Thus, in some embodiments, the power management module only charges the removable rechargeable battery 128 when a vehicle's engine is in operation.

The electrical ports 124A and 124B may operate as audio input and/or audio output for the reception and transmission of audio signals. In one embodiment, electrical port 124A may operate as an audio input, while electrical port 124B may operate as an audio output. In this embodiment, the electrical port 124A receives audio signals from an external source, such as a vehicle to which the cage tower speaker 100 is mounted, a portable device (i.e., an Apple iPod, MP3 player, smartphone, or similar music playing device), and transmits those audio signals to the control panel 118, processor, memory, and any combination thereof. Also, in this embodiment, the electrical port 124B transmits audio signals from the control panel 118, processor, memory, and any combination thereof to an audio system of a vehicle to which the cage tower speaker 100 is attached, or a portable device as described above.

Referring now to FIG. 7A, there is shown a rear view of the cage tower speaker 100 with the rear cover removed. This view also shows the mounting bracket 104 secured in a lengthwise orientation by the set screw 116, the conical taper of the outer housing 102, and the electrical ports 124A and 124B. With the rear cover removed, the rear cavity 126 is displayed. Within the rear cavity 126 is a removable and rechargeable battery 128 that mounts into a battery receiver with anode and cathode contacts that deliver power to and from the removable and rechargeable battery 128.

In some embodiments, the rear cavity 126 includes one or more one-way waterproof valves 129. The rear cavity 126 housing the battery 128 forms a rear wall of an interior cavity space housing the speaker driver 108 that separates the interior cavity space from the rear cavity 126. In the illustrative embodiment, a one-way waterproof valve 129 is located on the rear wall of the rear cavity 126, which controls the pressure differential between the interior cavity space and the rear cavity 126. The one-way waterproof valve 129 allows high pressure air to escape the interior cavity space (or isolated sound space) and prevents water, dirt, or mud from entering into the interior cavity.

In some embodiments, the one-way waterproof valve 129 is a membrane barrier operatively, fixedly, or otherwise coupled to the rear wall of the rear cavity 126, such that the membrane barrier covers the opening of a port of opening extending through the rear wall from the rear cavity 126 into the interior cavity space. The membrane barriers 129 may be a waterproof mesh material that allows air to pass through. One exemplary membrane barrier material is expanded polytetrafluoroethylene (ePTFE), especially as prepared by W.L. Gore & Associates, Inc. (i.e., Gore-Tex™). The ePTFE membrane material is a three-dimensional expansion of the linear base polymer PTFE that has a porous structure. In these embodiments where the membrane material is ePTFE, the membrane material may comprise multiple layers having unique compositions, wherein some layers may be the same composition as other layers and different compositions than still other layers. In these embodiments, the membrane barrier may operate by preventing liquid water from passing through while allowing nebulized or evaporate water particles through with air.

In some embodiments, the waterproof valves 129 may be mechanical one-way valves. In some embodiments, the waterproof valves 129 comprise a flap of waterproof material, one portion of which is affixed to a surface (i.e., a wall of the interior cavity and/or a wall of the rear cavity 126), while the remaining portions of the flap are unattached. By only partially affixing the flap of waterproof material to the surface surrounding a port through the surface, the flap may allow water through from the other side of the port, but slam closed when pressure is applied from the side of the surface to which the flap is attached. For example, a flap affixed to the interior surface of the interior sound space so that the flap covers a port from the interior sound space to the rear cavity 126 housing the battery, would swing open due to a pressure exerted from the rear cavity 126 and swing closed due to a pressure exerted from within the interior sound space.

One purpose of the membrane barriers 129 is to prevent a pressure differential from building up between the interior cavity (not shown) and the rear cavity 126 due to heat generated by the operation of the speaker driver assembly 108 and the extreme environments in which the cage tower speaker 100 operates, i.e. high air temperature and direct sunlight, or freezing temperatures. By allowing air to pass through the membrane barrier(s) 129, the membrane barrier(s) 129 act to conduct heat into or out of the interior cavity. Back pressure generated by the speaker driver assembly 108 may also escape through the membrane barrier(s) 129. A further purpose of the membrane barriers 129 is to allow pressure equalization between the rear cavity 126 and the interior sound space, without allowing any water to enter the rear cavity 126. Thus, the membrane barriers 129 may protect the rechargeable removable battery 128 from water and/or moisture.

The membrane barrier(s) 129 also prevent pressure from accumulating within the isolated sound space (i.e., acoustic-suspension box) that is the interior cavity for the speaker driver assembly 108, otherwise the pressure may accumulate until it is sufficient to dislodge the speaker driver assembly 108. Should the speaker be dislodged in this manner, it would decrease the sound quality produced by the cage tower speaker 100 by adding unintended vibrations from the dislodged speaker assembly 108. Further, water seeping through a dislodged element into the interior of the outer housing 102 may degrade or short-out internal electrical connections between the speaker 108 and either the control panel 118 or the battery 128. Further, water seeping through a dislodged element into the interior of the outer housing 102 may enter the control panel 118 itself. Water seeping into the interior sound space may corrode and/or short any of the control panel connections or elements, such as the electrical ports 124A and 124B. Such water damage would shorten the operable life span of the cage tower speaker 100 or disable it entirely. However, the membrane barrier(s) 129 limit, prevent, and/or eliminate such degradation of the cage tower speaker 100 and extend its operable life span.

At the same time, although not necessarily so, the membrane barrier(s) 129 equalize the internal pressure present within the interior of the outer housing 102 (i.e., the interior sound space 130) with the pressure in the rear cavity 126, by allowing air to pass into or out of the interior of the outer housing 102 through the membrane barrier (not shown) without allowing water, dirt, or other debris to enter the outer housing 102 interior.

In some embodiments, when enclosed by the rear cover, the rear cavity 126 is a sealed, watertight compartment that protects the battery 128 and other interior electrical components of the cage tower speaker 100. The seal may be formed by a rubber O-ring or comparable sealing element seated about the exterior border of the rear cavity 126 and between the rear cavity 128 and the rear cover.

With reference now to FIG. 7B, there is shown the removable rechargeable battery 128 isolated from the rear cavity 126 of the cage tower speaker 100. In some embodiments, the removable rechargeable battery 128 is a Nickel-Cadmium (NiCd) battery. In some embodiments, the removable rechargeable battery 128 is a Nickel-Metal Hydride (NiMH) battery. In some embodiments, the removable rechargeable battery 128 is a Lithium Ion (Li-ion) battery. In some embodiments, the removable rechargeable battery 128 is surrounded by a durable casing that encloses the battery components. The durable casing may be rigid, waterproof, and/or impact resistant.

Referring now to FIG. 7C, there is shown the rear cover 106 removed from the outer housing and the depressor button 120 disengaged from any latch on the outer housing.

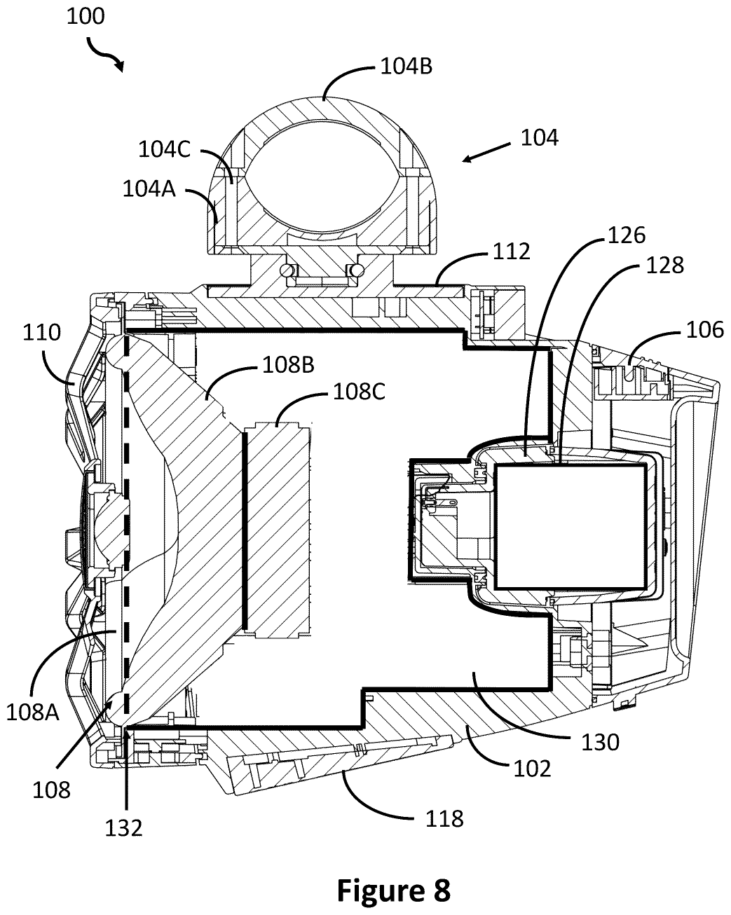

Referring now to FIG. 8, there is shown a cutaway view of the illustrative cage tower speaker 100. This cutaway view displays the two-piece structure of the illustrative ring mounting bracket 104. The illustrative two-piece ring mounting bracket 104 comprises a bracket base 104A and a bracket top piece 104B held together by one or more fasteners, screws, or threaded bolts inserted into a receiver opening 104C. In some embodiments, the two-piece ring mounting bracket 104 includes only a single receiver opening 104C on a front or back side of the two-piece ring mounting bracket 104 and a single pivot point on a side opposite the single receiver opening 104C. In this embodiment, the single pivot point allows the bracket top piece 104B to rotate open and rotate closed about the pivot point, while a fastener inserted into the receiver opening 104C when in the closed position secures the bracket top piece 104B in the closed position. The pivot point may include a pivot fastener that has a head or flange that is wider or larger than the width of the slot 104C.

The cutaway view of FIG. 8 shows the plate shape of the mounting inlay 112 attached to the surface of the outer housing 102. This view further shows the various components of the speaker driver assembly 108, such as the speaker driver cone 108A, the speaker chassis 108B, and the speaker base 108C. In some embodiments, the speaker base 108C comprises a front plate, a magnet, and a yoke. In some embodiments, the speaker driver cone 108A spans a frontal opening of the speaker chassis 108B and/or the frontal opening of the outer housing 102, while the speaker chassis 108B and the speaker base 108C sit within the interior cavity space 130 that is separated from the control panel 118 by the outer housing 102. The outer circumferential surface of the speaker driver 108 and the inner circumferential surface of the speaker grill 110 are sized and configured to interface with one another and the outer housing 102. Together, the speaker driver assembly 108 and the outer housing 102 form an isolated sound space into which sound waves and back pressure from the speaker driver assembly 108 are emitted. The rear cavity 126 housing the battery 128 forms a rear wall of the interior cavity space 130 that separates the interior cavity space 130 from the rear cavity 126. The frontal opening 132 is depicted with a dotted line in FIG. 8, while the interior cavity 130 is delineated by the bold black line and includes the rear wall.

The sound waves and/or back pressure generated by the speaker driver 108 are directed by the rear wall of the interior cavity space 130 outward back toward the frontal opening. In this manner, the interior cavity space 130 acts as an acoustic-suspension box or air-suspension box that cause back pressure or sound waves generated by speaker driver 108 to be directed outward along the lengthwise axis of the cage tower speaker 100 from the speaker driver 108 and the cage tower speaker 100.

In operation, the cage tower speaker 100 emits sound waves from the speaker driver assembly 108 according to input received from the control panel 118. The input may be the result of a user pressing one or more of the buttons on the control panel 118 or from a music file uploaded, input, or otherwise present upon a processor (not shown) of the cage tower speaker 100. In the illustrative embodiment, the speaker driver assembly 108 is located in the frontal circular opening of the outer housing 102 and emits sound waves outward from the frontal circular opening along a central lengthwise axis of the outer housing 102, while simultaneously emitting sound waves and/or back pressure into the interior sound space 130 also along the central lengthwise axis to rear wall of the interior cavity 130.

User commands input at or through the control panel 118 may also control the operation of the LED lights resident within the speaker 108. However, the operation of the various LED lights may be automated in conjunction with music played by the cage tower speaker 100 and require no specific input from a user.

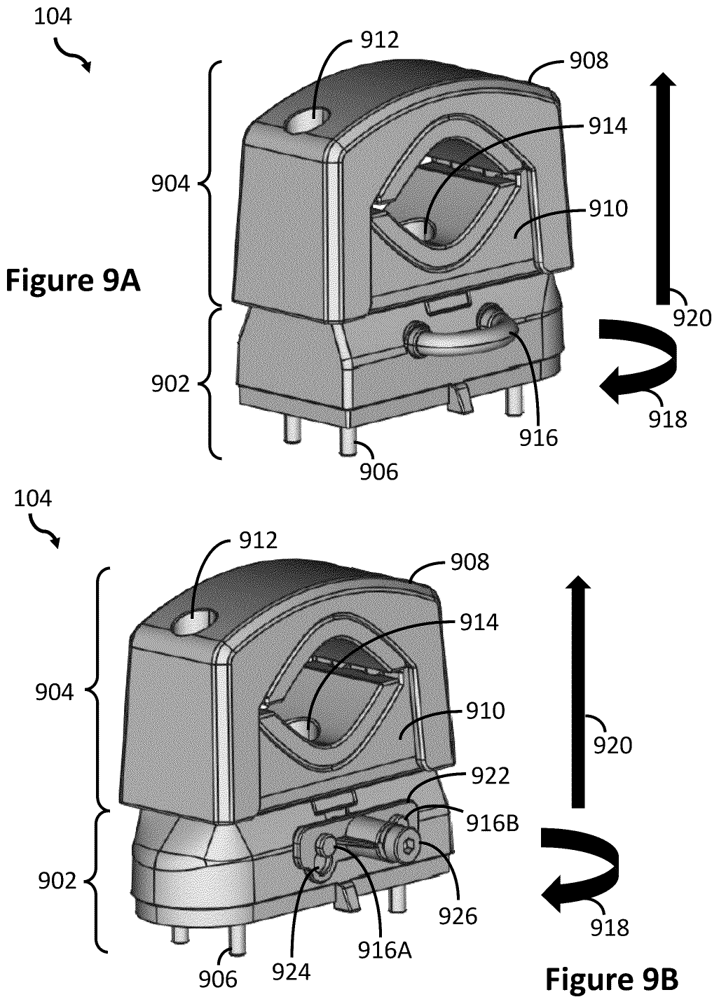

With reference now to FIGS. 9A and 9B, there is shown a mounting bracket 104 embodied as a releasable, lockable mounting clamp. The releasable, lockable mounting clamp 104 includes a mount base 902 and a clamp 904. The mount base 902 may be affixed to a cage tower speaker unit with screws or similar fasteners 906 extending from the bottom of the mount base 902 through the mounting inlay 112 (shown in FIGS. 1 and 8) of the cage tower speaker unit. In some embodiments, the mount base 902 lacks fasteners 906, and is instead an integral component of a cage tower speaker unit. The mount base 902 may be molded, forged, machined, or printed from plastic, metal (e.g., aluminum, titanium, steel, stainless steel), metal alloy, composite, carbon fiber, or any other suitable material.

The clamp 904 includes an upper portion 908 and a lower portion 910 that may be affixed about a pipe, pole, tube, rod, or other structure, particularly structures present on a vehicle. The upper portion 908 and lower portion 910 of the clamp 904 form a cavity or opening through which the pipe, pole, tube, rod, or other structure may extend. The upper portion 908 and lower portion 910 of the clamp 904 may be secured to one another with screws or similar fasteners (not shown) passing through receiver openings 912 extending through both the upper portion 908 and lower portion 910 of the clamp 904.

The clamp 904 also includes an electrical connector passage 914 that may receive or comprise multi-pin aviator connectors, deutsch connectors, or comparable electrical connections. The electrical connector passage 914 is central to the clamp 904 and aligned along an axis of rotation of the mounting bracket 104 so that the electrical connector passing there through may rotate without twisting unduly or binding upon itself and/or the structures of the mounting bracket 104.

In some embodiments, the electrical connector passage 914 passes through the lower portion 910 of the clamp 904, such that it is oriented to allow an electrical connector or electrical lines to pass through the lower portion 910 of the clamp 904 into a pipe, pole, tube, rod, or other structure to which the mounting bracket 104 is affixed.

A pronged securing key 916 couples the mount base 902 to the clamp 904 by extending through a quick-release engagement mechanism (not shown). The securing key 916 may be a fork structure constructed from plastic, metal (e.g., aluminum, titanium, steel, stainless steel), metal alloy, composite, carbon fiber, or any other suitable material. The securing key 916 and quick-release engagement mechanism (not shown) allows the mount base 902 and clamp 904 to swivel, pivot, or rotate with respect to one another, and thus allows a cage tower speaker unit affixed to the mount base 902 to swivel, pivot, or rotate with respect to any pipe, pole, tube, rod, or other structure to which the clamp 904 is affixed. In the illustrative embodiment, the mount base 902 rotates in a horizontal plane 918 that is perpendicular and orthogonal to the vertical alignment 920 of the mounting bracket 104.

FIG. 9A shows a first side of the mounting bracket 104, while FIG. 9B shows a second side of the mounting bracket 104 that is opposite the first side. In FIG. 9B, the prongs 916A and 916B of the securing key 916 are shown protruding from a securing plate 922. The securing plate 922 may be constructed from plastic, metal (e.g., aluminum, titanium, steel, stainless steel), metal alloy, composite, carbon fiber, or any other suitable material. The securing plate 922 includes receiving slots 924 for each prong 916A and 916B, as well as a threaded opening that receives a set screw 926 of a set screw assembly that may further include a stopper screw (not shown). The receiving slots 924 have two portions, a wide portion and a narrow portion. The wide portion is also termed the unlocked portion, while the narrow portion is also termed the locking portion. In FIG. 9B, the wide portion of the slot 924 is visible, while the prong 916A of the securing key 916 extends through the narrow portion of the slot 924. The wide portion of the slot(s) 924 is wider than an outer diameter of the prong 916A, while the narrow portion of the slot 924 is narrower than the outer diameter of the prong 916A and wider than the diameter of a groove (not shown) on the prong 916A. The wide portion of the slot 924 allows the prong 916A to pass through, while the narrow portion of the slot settles into the groove (not shown) of the prong 916A and holds the securing fork 916 in place in the engagement mechanism (not shown).

The set screw assembly 926 threads into the threaded set opening (not shown) of the securing plate 922. When threaded fully into the threaded set opening (not shown), the set screw assembly arrests the rotation of the mounting bracket 104, locking the mount base 902 and the clamp 904 in a particular rotational orientation. Additionally, when threaded fully into the threaded set opening (not shown), the set screw assembly locks the securing key 916, securing plate 922, and engagement mechanism (not shown) together and prevents any cage tower speaker unit affixed thereto from falling from its mounted position.

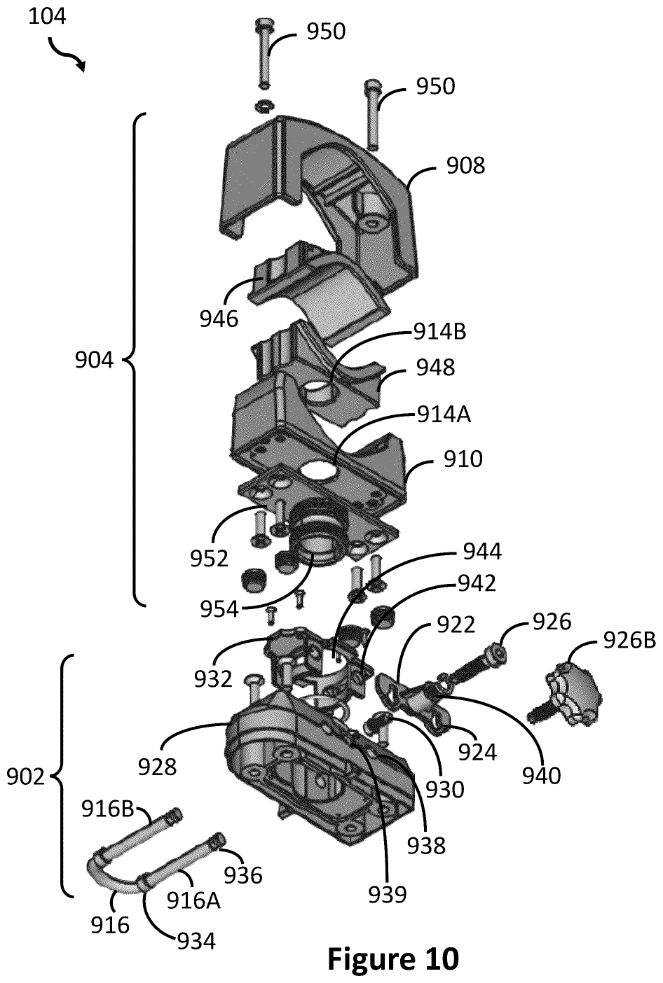

Referring now to FIG. 10, there is shown an exploded view of the releasable, lockable mounting clamp 104 components. In this illustrative embodiment, the base mount 902 includes a base fixture 928, the securing key 916, the securing plate 922, the set screw 926, the stopper screw 930, and an outer annular structure 932. The illustrative securing key 916 includes two prongs 916A and 916B that are aligned parallel to one another. In some embodiments, the securing key 916 includes only a single prong. In some embodiments, the securing key 916 includes more than two prongs. Each prong 916A and 916B includes a stopping structure 934, such as a collar, and a locking groove 936. The stopping collar 934 has a diameter that is larger than an outer diameter of the prongs 916A and 916B, while the locking grooves 936 have a diameter that is less than the outer diameter of the prongs 916A and 916B.

The illustrative securing key 916 has cylindrical prongs 916A and 916B with circular cross-sections. In some embodiments, the prongs 916A and 916B may instead be bars having oval cross-sections, square cross-sections, rectangular cross-sections, triangular cross-sections, or a comparable geometric cross-sectional shape.

The base fixture 928 may be constructed of metal (e.g., aluminum, titanium, steel, stainless steel), a metal alloy, a composite, plastic, carbon fiber, and a combination thereof. The base fixture 928 includes one or more receiving openings 938 that pass through the base fixture 928 from a rear side of the base fixture 928 (not shown) to a front side of the base fixture 928. In various embodiments, the base mount fixture includes a number of receiving openings 938 corresponding to the total number of securing key prongs employed by the base mount 902 (e.g., the base fixture 928 may include two receiving openings 938 when the base mount 902 includes two single pronged securing keys or one two-pronged securing key 916). The receiving openings 938 are sized and configured to receive the prongs 916A and 916B of the securing key 916 so that the prongs 916A and 916B pass through the base fixture 928 and the slot(s) 924 of the securing plate 922 when the securing key 916 is fully inserted into the receiving openings 938. Thus, the diameter of the receiving openings 938 are greater than the outer diameter of the prongs 916A and 916B. However, the diameter of the receiving openings 938 are smaller than the diameter of the stopping collars 934. The securing key 916 is fully inserted into the base fixture 928 when the stopping collar(s) 934 abuts the base fixture 928 and cannot be inserted further into the base fixture 928.

The base fixture 928 further includes a set screw opening 939 that receives the stopper screw 930 and/or the set screw 926. The set screw opening 939 does not pass entirely through the base fixture 928, instead passing only from the front exterior of the base fixture 928 into an interior space surrounding the outer annular structure 932 and receives the inner annular structure 952. In the illustrative embodiment, the set screw opening 939 is circular and of a diameter larger than the outer diameters of both the set screw 926 and the stopper screw 930 head. In some embodiments, the set screw opening 939 is slot-shaped with a width that is larger than the outer diameter of the set screw 926, but narrower than the outer diameter of the stopper screw 930 head. In some embodiments, the set screw opening 939 is slot-shaped with a width that is larger than the outer diameters of both the set screw 926 and the stopper screw 930 head.

In the illustrative embodiment, the slot 924 includes a narrow locking portion situated directly above a wide unlocked portion. The wide portion of the slot 924 is sized larger than an outer diameter of the securing key prongs 916A and 916B and configured to receive the prongs 916A and 916B. The narrow locking portion of the slot 924 is sized smaller than the outer diameter of the securing key prongs 916A and 916B so that the prongs 916A and 916B cannot pass through the narrow locking portion of the slot 924. However, the narrow locking portion of the slot 924 is sized larger than the diameter of the locking grooves 936 so that the prongs 916A and 916B may slide into the narrow locking portion of the slot 924 when the slot 924 is aligned with the locking groove 936.

The stopper screw 930 includes threading along a shaft that is narrower than the outer diameter of the set screw 926. The threaded shaft of the stopper screw 930 meshes with threading internal to the set screw 926. When threaded into the set screw 926, the stopper screw 930 and set screw 926 together comprise the set screw assembly. The stopper screw 930 includes a head adjacent to the inner annular structure 928 that has a larger diameter than the shaft of the set screw 926 and the opening 940 in the securing plate 922 through which the set screw 926 passes. This head of the stopper screw 930 prevents the set screw assembly from being removed from the securing plate 922 without disassembling the set screw assembly, i.e., removing the stopper screw 930 from the set screw 926. In the illustrative embodiment, the set screw 926 is a machine screw having a hex head that requires an Allen wrench or hex key to tighten, loosen, or remove. In some embodiments, the set screw assembly instead includes a hand-held set screw 926B that can be tightened, loosened, or removed by hand and without any tools. The hand-held set screw 926B includes a knob instead of a hex-key head or bolt head. The knob is sized and contoured to be gripped and operated by hand.

The outer annular structure 932 fits within and may be secured to the base fixture 928. In some embodiments, the outer annular structure 932 is secured to the base fixture 928 with screws or fasteners. In some embodiments, the outer annular structure 932 is an integrated component of the base fixture 928. In some embodiments, the outer annular structure 932 is affixed to, or integrated with, the clamp 904 instead of the base fixture 928. The outer annular structure includes one or more slot structures 942 and a central annular cavity 944. The slot structures 942 are oriented horizontally and configured to allow the prongs 916A and 916B to pass there through. The central annular cavity 944 is oriented vertically and orthogonal to the slot structures 942.

The clamp 904 includes an upper portion 908, an upper inlay 946, a lower portion 910, a lower inlay 948, clamp fasteners 950, and an inner annular structure 952. The upper inlay 946 is contoured to fit within the clamp upper portion 908 and the lower inlay 948 is contoured to fit within the clamp lower portion 910. Either or both of the upper inlay 946 and the lower inlay 948 may include a cushioned and/or textured surface configured to contact a pipe, pole, tube, rod, or other structure about which the clamp 904 may be affixed. In some embodiments, the cushioned and/or textured surface includes a rubber layer, a foam layer, or a layer of comparable material.

The clamp fasteners 950 may be machine screws, bolts, or comparable fasteners that are configured to pass through receiving openings in the clamp upper portion 908 and into a nut-plate or threaded opening in the clamp lower portion 910. Thus, the clamp fasteners 950 may secure the clamp upper portion 908 to the clamp lower portion 910 about a pipe, pole, tube, rod, or other structure, thereby affixing the mounting bracket 104 and any cage tower speaker unit attached thereto, such as to a vehicle or other structure. In some embodiments, the clamp fasteners 950 further secure the upper inlay 946 and/or the lower inlay 946 about a pipe, pole, tube, rod, or other structure and within the clamp upper portion 908 and lower portion 910, respectively. In the illustrative embodiment, the clamp lower portion includes a central passage 914A through which electrical connectors may pass. Similarly, the lower inlay 948 may include a central passage 914B through which electrical connectors may pass.

In the illustrative embodiment, the inner annular structure 952 includes a central annulus 954. In the illustrative embodiment, the inner annular structure 952 may be secured to a bottom surface of the clamp 904, such as a bottom surface of the clamp lower portion 910. In some embodiments, the inner annular structure 952 is secured to the bottom surface of the clamp 904 or clamp lower portion 910 with screws or fasteners. In some embodiments, the inner annular structure 952 is an integrated component of the clamp lower portion 910. In some embodiments, the inner annular structure 952 is affixed to, or integrated with, the base fixture 928 of the base mount 902 instead of the clamp 904.

In the illustrative embodiment, the central annulus 954 has an outer diameter sized and configured to fit within the central annular cavity 944 of the outer annular structure 932. Similarly, the annular surfaces of the outer annular structure 932 that delineate the central annular cavity 944 are contoured to correspond to the shape and size of the inner annular structure's central annulus 954, i.e. the annular surfaces are contoured to extend about and around the central annulus 954. Together, the clamp lower portion central passage 914A, the lower inlay central passage 914B, the outer annular structure 932 central annular cavity 944, and the inner annular structure 952 central annulus 954 form the electrical connector passage 914 (shown in FIGS. 9A and 9B), allowing one or more electrical connecter and/or wire to pass there through and couple to cage tower speaker unit affixed to the mounting bracket 104.

The inner annular structure 952 and the outer annular structure 932 operate together to form an engagement mechanism when the securing key 916 is inserted through the base fixture 928 and the outer annular structure 932, so that the prong(s) of the securing key 916 abut an engagement groove of the central annulus 954. When so engaged, the engagement mechanism affixes the base mount 902 to the clamp 904, while allowing the base mount 902 to rotate with respect to the clamp 904.

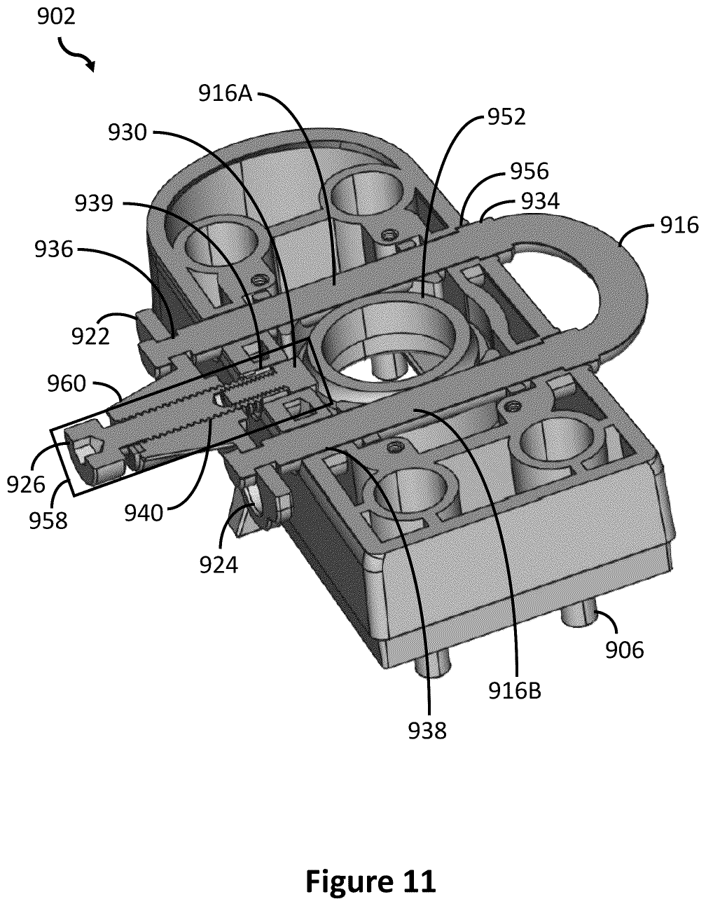

Referring now to FIG. 11, there is shown a cross-sectional view of the base mount 902 along a horizontal plane. This cross-sectional view displays how the prongs 916A and 916B of the securing fork 916 pass through the base mount 902 and the inner annular structure 952 of the clamp 904. In this illustrative embodiment, the securing fork 916 includes a backbone linking two prongs 916A and 916B together into the form of a U-bolt. In some embodiments, the U-shaped backbone of the securing fork 916 prevents the prongs 916A and 916B from passing entirely through the base mount 902, instead stopping the securing fork 916 at a fully inserted position. Thus, the U-shaped bend in the U-bolt operates as the stopping structure 934 that prevents the prong(s) of the securing key 916 from passing entirely through the base fixture 928.

In the illustrative embodiment, a stopping collar or band 934 having a diameter greater than the outer diameter of the prongs 916A and 916B abuts the base mount 902 to prevent the prongs 916A and 916B from passing entirely through the base mount 902 and stop the securing fork 916 at a fully inserted position. In the illustrative embodiment, the slot or opening 938 in the base mount 902 through which the prong(s) 916A and/or 916B extend includes an inset 956 that receives the stopping collar or band 934. In this illustrative embodiment, the prongs 916A and 916B include a locking groove 936 which is configured to rest within a narrow locking portion of the slot 924 in the securing plate 922.

In the illustrative embodiment, a set screw assembly 958 includes the set screw 926 and the stopper screw 930 that abuts the inner annular structure 952 when the set screw assembly 958 is fully engaged through the securing plate 922 and the set screw opening 939. As described above, the stopper screw 930 includes threading along a shaft that is narrower than the outer diameter of the set screw 926. When the threaded shaft of the stopper screw 930 meshes and engages with threading internal to the set screw 926, the two components form an assembled set screw assembly 958. The stopper screw 930 includes a head that may be placed adjacent to the inner annular structure 952. In the illustrative embodiment, the stopper screw 930 head has a larger diameter than the shaft of the set screw 926 and the opening 940 in the securing plate 922 through which the set screw 926 passes. The stopper screw 930 head prevents the set screw assembly 958 from being removed from the securing plate 922 without disassembling the set screw assembly 958, i.e., removing the stopper screw 930 from the set screw 926.

In the illustrative embodiment, the opening 940 includes internal threading that meshes and engages with the external threading along the shaft of the set screw 926. The internal threading of the opening 940 in the securing plate 922 enables the incremental movement of the set screw assembly 958 through the securing opening 940 so that the set screw assembly 958 may be secured in a fully engaged position where the head of the stopper screw 930 firmly abuts the engagement groove of the central annulus 954. The internal threading of the opening 940 also enables removal of the set screw assembly 958 from the set screw opening 939 by placing the set screw assembly 958 in a removed position or unlocked position.

In the illustrative embodiment, the set screw opening 939 is circular and of a diameter larger than the outer diameters of both the set screw 926 and the stopper screw 930 head. In this illustrative embodiment, the set screw assembly 958 must be removed from the set screw opening 939, i.e. be placed in the removed or unlocked position, so that the set screw assembly 958 and the securing plate 922 can be shifted up into an unlocked position that orients the prong(s) 916A and/or 916B through the wider unlocked portion of the receiving slot 924. Once oriented through wider unlocked portion of the receiving slot 924, both the securing plate 922 and the set screw assembly 958 can be removed from the base mount 902. With the securing plate 922 and the set screw assembly 958 removed, the securing key 916 can then be removed from the engagement mechanism, i.e., the base fixture 928 and the outer annular structure 952, so that the base mount 902 and any speaker unit affixed thereto can be stored or moved to another mounting location.

When the set screw assembly 958 is placed in the unlocked position, the orientation of the narrow locking portion of the receiving slot 924, above the wider unlocked portion of the receiving slot 924, causes gravity to hold the securing plate 922 within the locking groove 936 of the securing key prong 916A or 916B and prevent the securing plate 922 from simply slipping off the securing key prong 916A or 916B and falling. This mechanism simplifies the operation of the mounting bracket 104, reducing the likelihood that the securing plate 922 could become lost.

In operation, the weight of a speaker unit affixed to the base mount 902 creates a modicum of friction that prevents the securing key 916 from simply slipping out of the base fixture 928 and the outer annular structure 952, thus continuing to hold the mounting bracket 104 together.

When the set screw assembly 958 is placed in the unlocked position, the wider unlocked portion of the receiving slot 924 on the securing plate 922 can be passed over the prong(s) 916A and/or 916B of a securing key 916 inserted through the outer annular structure 952 and base fixture 928. Once the prong(s) 916A and/or 916B of the securing key 916 have been placed into the wider unlocked portion of the receiving slot 924 on the securing plate 922, the securing plate 922 can be shifted down into a locked position where the narrower locking portion of the receiving slot 924 slides over or into the locking groove 936 of the securing key prong 916A or 916B. Once in this locked position, the set screw assembly 958 aligns with the set screw opening 939 and the set screw assembly can be tightened into an engaged position where the stopper screw 930 abuts the central annulus 954.

In the illustrative embodiment, the opening 940 through which the set screw assembly 958 passes includes a spacing sleeve 960 protruding from a surface of the securing plate 922. The distance which the spacing sleeve 960 protrudes outward from the securing plate 922 surface corresponds to the length of the set screw assembly 958 and the distance to the inner annular structure 952 so that the stopper screw 930 only abuts the inner annular structure 952 when the set screw assembly 958 is fully inserted into the spacing sleeve 960.

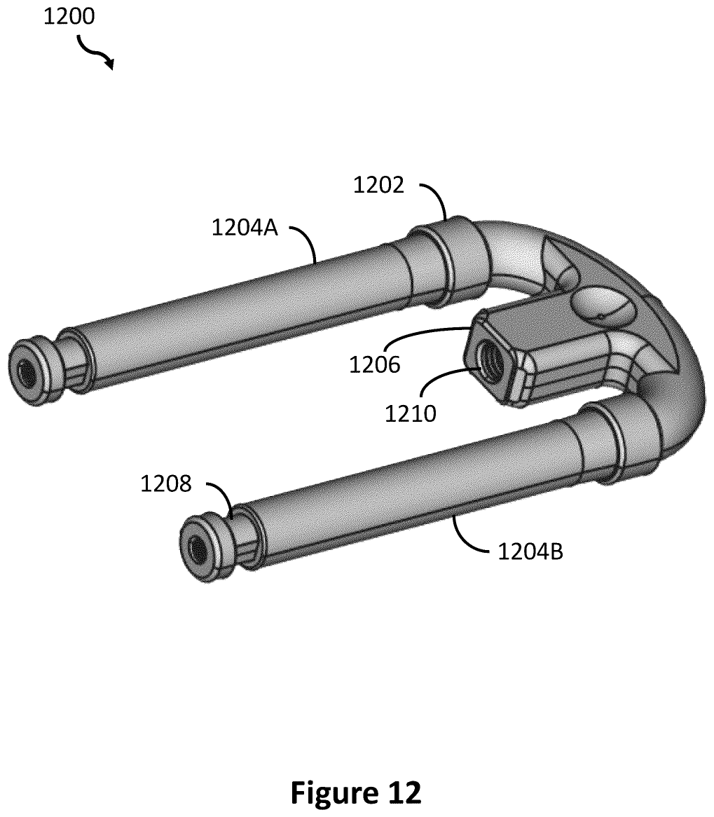

With reference now to FIG. 12, there is shown an isometric view of an alternative securing fork 1200 that, like securing fork 916 (shown above in FIGS. 9A-11), includes at least one stopping collar 1202, two parallel and linear prongs 1204A and 1204B, and at least one locking groove 1208. The alternative securing fork 1200 further includes a stopper prong 1206 extending from the U-shaped backbone along the same plane and parallel to the prongs 1204A and 1204B.

In the illustrative second embodiment 1200, the stopper prong 1206 has a rectangular cross-sectional shape with rounded corners. In some embodiments, the stopper prong 1206 has a rectangular cross-sectional shape with sharp corners. In some embodiments, the stopper prong 1206 has a circular cross-sectional shape. In some embodiments, the stopper prong 1206 has an oblate cross-sectional shape.

In the illustrative second embodiment 1200, the stopper prong 1206 includes a receiving opening 1210 located on the terminal face of the stopper prong 1206. The receiving opening 1210 may be threaded to receive a correspondingly threaded securing stopper screw (not shown). In some embodiments, the receiving opening 1210 is merely a slot without any internal threading. While the receiving opening 1210 in the illustrative embodiment is circular, it may also be rectangular or oblate.

While the illustrative embodiments of both securing forks 916 and 1200 show prongs 916A, 916B, 1204A, and 1204B having a uniform cylindrical shape with a single consistent cross-section diameter, the prongs may be embodied as other shapes. In the illustrative embodiments, the prongs 916A, 916B, 1204A, and 1204B of the securing fork 916 or 1200 are uniformly cylindrical. In some embodiments, the prongs 916A, 916B, 1204A, and 1204B may have a rectangular cross-section or an oblate cross-section.

In one embodiment, the securing fork prongs 916A, 916B, 1204A, or 1204B may include a taper, such that the cross-sectional size of the prong proximate to the stopper collar 934 or 1202 is larger than the cross-sectional size of the prong 916A, 916B, 1204A, or 1204B more distal to the stopper collar 934 or 1202. The taper may be continuous such that the cross-sectional size of the prong 916A, 916B, 1204A, or 1204B decreases consistently along the length of the prong 916A, 916B, 1204A, or 1204B from the stopper collar 934 or 1202 to the terminus of the prong 916A, 916B, 1204A, or 1204B. In some embodiments, the taper occupies only a portion of the length of the prong 916A, 916B, 1204A, or 1204B, such that the prong comprises three sections between the stopper collar 934 or 1202 and the terminus of the prong. A first section has a large uniformly sized cross-section and is proximate to the stopper collar 934 or 1202. A second section has a uniformly sized cross-section that is smaller than the first section cross-section and is proximate to the terminus of the prong 916A, 916B, 1204A, or 1204B. A third section is located between the first and second sections and tapers from the large cross-section down to the smaller cross-section size.

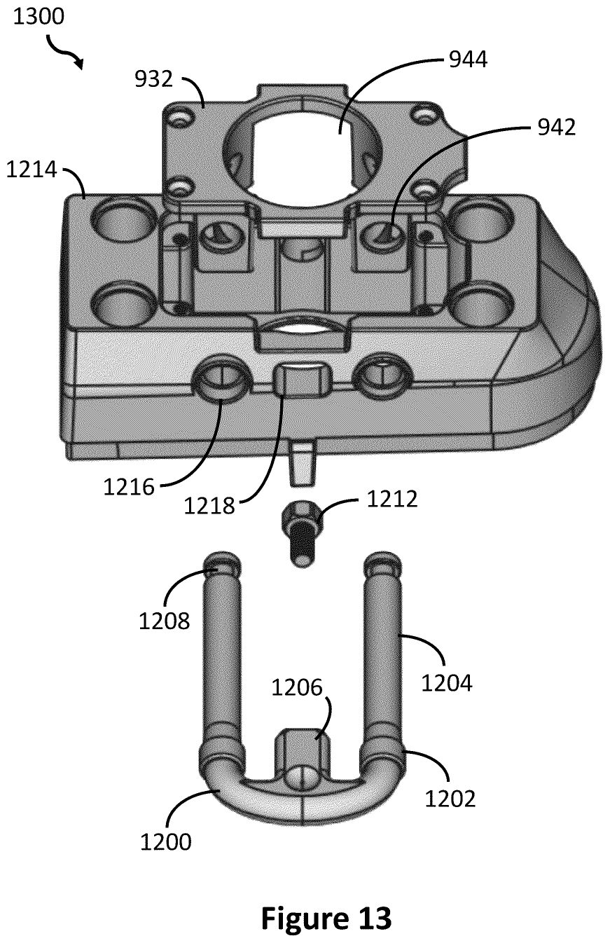

Referring now to FIG. 13, there is shown an exploded view 1300 of the securing fork 1200, a corresponding base mount 1214, a prong stopper 1212, and the outer annular structure 932. The exploded view 1300 shows the prong stopper 1212 in the form of a screw that is configured to be received by the receiving opening 1210 (not shown) in the terminus of the stopper prong 1206. While the illustrative prong stopper 1212 is embodied as a screw, it may also be a rubber or silicone plug.

The base mount 1214 is substantially similar to base mount 902 (described above in FIGS. 9A-10) having openings 1216 that pass through the base mount 1214 from a rear side of the base mount 1214 (not shown) to a front side of the base mount 1214. In various embodiments, the base mount 1214 includes a number of receiving openings 1216 corresponding to the total number of securing key prongs 1204 employed (e.g., the base mount 1214 may include two receiving openings 1216 when the base mount 1214 includes two single pronged securing keys or one two-pronged securing key 1200). The receiving openings 1214 are sized and configured to receive the prongs 1204 of the securing key 1200 so that the prongs 1204 pass through the base mount 1214 and the slot(s) 924 of the securing plate 922 when the securing key 1200 is fully inserted into the receiving openings 1216. Thus, the size or dimensions of the receiving openings 1216 are greater than the cross-sectional size or dimensions of the prong(s) 1204. However, the receiving openings 1216 are smaller than the stopping collars 1202 and do not allow the stopping collars 1202 to pass through the receiving openings 1216. The securing key 1200 is fully inserted into the base mount 1214 when the stopping collar(s) 1202 abuts the base mount 1214 and cannot be inserted further into the base mount 1214.

The base mount 1214 further includes a stopper opening 1218 located relative to the receiving openings 1216 such that the stopper opening 1218 receives the stopper prong 1206 when the receiving openings 1216 are aligned to receive the securing prong(s) 1204. In the illustrative embodiment, the stopper opening 1218 is rectangular with rounded corners, corresponding to the cross-sectional shape of the illustrative stopper prong 1206. In various embodiments, the stopper opening 1218 may be circular, oblate, or rectangular with sharp corners. In these various embodiments, the stopper opening 1218 shape corresponds to the cross-sectional shape of the stopper prong 1206.

The base mount 1214 receives the outer annular structure 932 just as base fixture 928 (shown above in FIGS. 10 and 11) receives the outer annular structure 932. In some embodiments, the outer annular structure 932 is secured to the base mount 1214 with screws or fasteners. In some embodiments, the outer annular structure 932 is an integrated component of the base mount 1214. In some embodiments, the outer annular structure 932 is affixed to, or integrated with, the clamp 904 (described above in FIGS. 9A-10) instead of the base mount 1214. The outer annular structure includes one or more slot structures 942 and a central annular cavity 944. The slot structures 942 are oriented horizontally and configured to allow the prongs 1204 to pass there through. The central annular cavity 944 is oriented vertically and orthogonal to the slot structures 942.

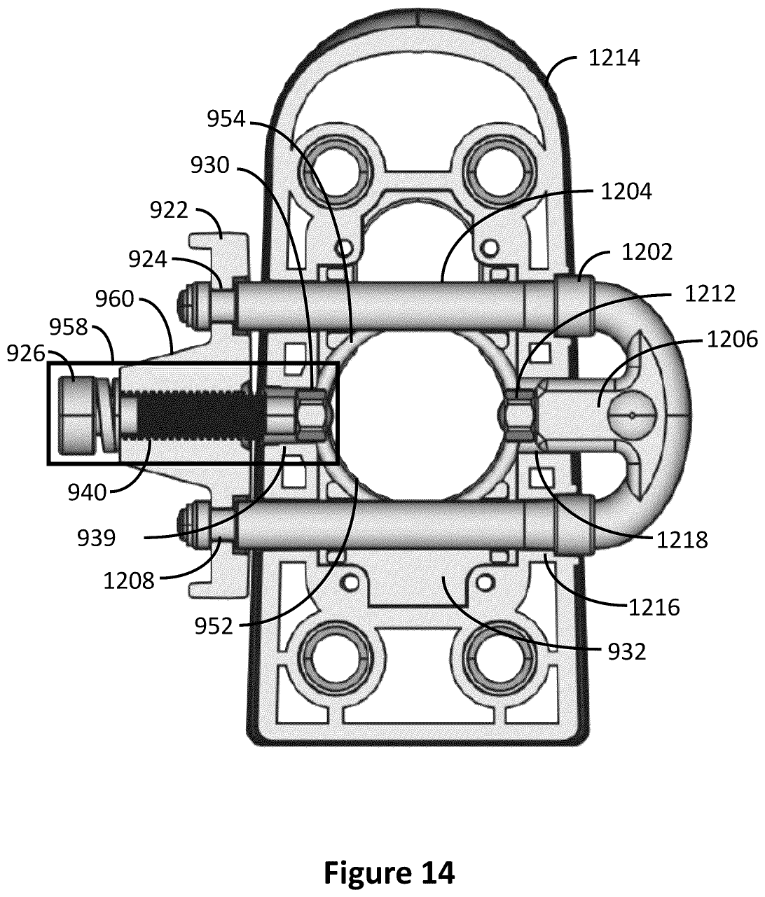

With reference now to FIG. 14, there is shown a cross-sectional view of the base mount 1214 along a horizontal plane. This cross-sectional view displays how the prongs 1204 of the securing fork 1200 pass through the base mount 1214 and the inner annular structure 952 of the clamp (shown in FIGS. 9A and 9B as reference number 904), while the stopper prong 1206 passes into the stopper opening 1218 and through a space, orifice, or gap (not shown) in an annular wall of the outer annular structure 932 that aligns with the stopper opening 1218 to abut the central annulus 954 of the inner annular structure 952.

In the illustrative embodiment, a stopping collar 1202 having a diameter greater than the outer diameter of the prongs 1204 abuts the base mount 1214 to prevent the prongs 1204 from passing entirely through the base mount 1214 and stop the securing fork 1200 at a fully inserted position. In the illustrative embodiment, the prongs 1204 include a locking groove 1208 configured to rest within a narrow locking portion of a slot 924 in the securing plate 922.

In the illustrative embodiment, the stopper prong 1206 includes a screw-type prong stopper 1212. The stopper prong 1206 and prong stopper 1212 are configured to abut the central annulus 954 of the inner annular structure 952 when the securing fork 1200 is at the fully inserted position.

As described above with reference to FIG. 11, the stopper screw 930 of the set screw assembly 958 abuts the inner annular structure 952 when the set screw assembly 958 is fully engaged through the securing plate 922 and the set screw opening 939. The internal threading of the opening 940 in the securing plate 922 enables the incremental movement of the set screw assembly 958 through the securing opening 940 so that the set screw assembly 958 may be secured in a fully engaged position where the head of the stopper screw 930 firmly abuts the engagement groove of the central annulus 954. In this fully engaged position, both the stopper screw 930 and prong stopper 1212 firmly abut the engagement groove of the central annulus 954, preventing rotation of the mounting bracket 104, locking the mount base 1214 and the clamp 904 in a particular rotational orientation. When the set screw assembly 958 is retracted from the fully engaged position such that the set screw assembly 958 is not in contact with the engagement groove of the central annulus 954 and the securing fork 1214 is in the fully engaged position, the prongs 1204 and the stopper prong 1206 of the securing key contact the engagement groove of the central annulus 954, holding the clamp 904 and the mount base 1214 of the mounting bracket 104 together and supporting the weight of any speaker attached to the mounting bracket 104.

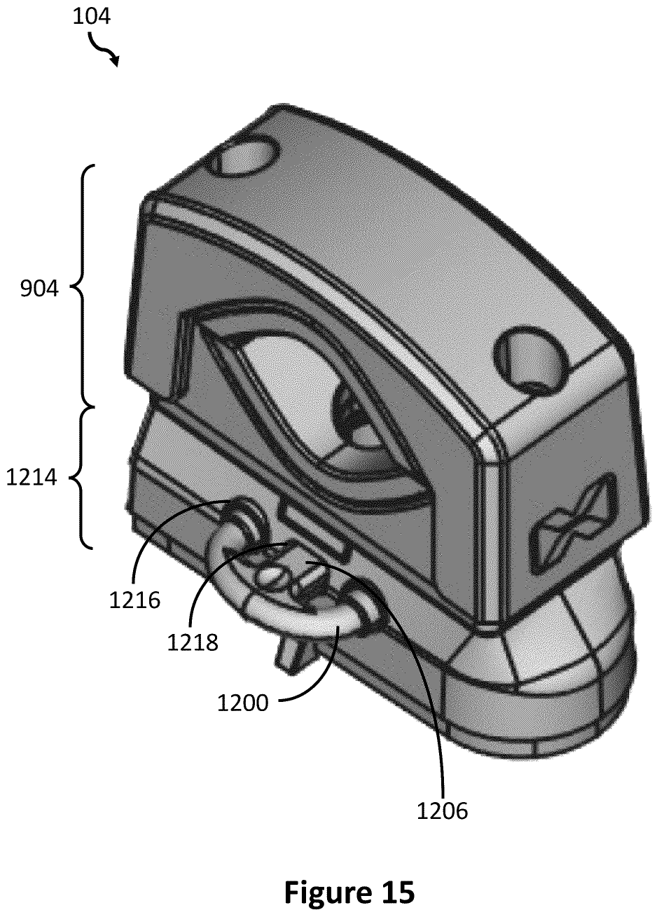

Referring now to FIG. 15, there is shown a mounting bracket 104 embodied as a releasable, lockable mounting clamp 104 including a mount base 1214 and a clamp 904. The mount base 1214 may be affixed to a cage tower speaker unit with screws or similar fasteners (not shown) extending from the bottom of the mount base 1214 through the mounting inlay 112 (shown in FIGS. 1 and 8) of the cage tower speaker unit. In some embodiments, the mount base 1214 lacks fasteners, and is instead an integral component of a cage tower speaker unit. The mount base 1214 may be molded, forged, machined, or printed from plastic, metal (e.g., aluminum, titanium, steel, stainless steel), metal alloy, composite, carbon fiber, or any other suitable material. The mounting bracket 104 is shown with the securing key 1200 fully inserted into the mount base 1214, such that the prongs 1204 pass through the receiving openings 1216 and the stopper prong 1206 passes into the stopper opening 1218.

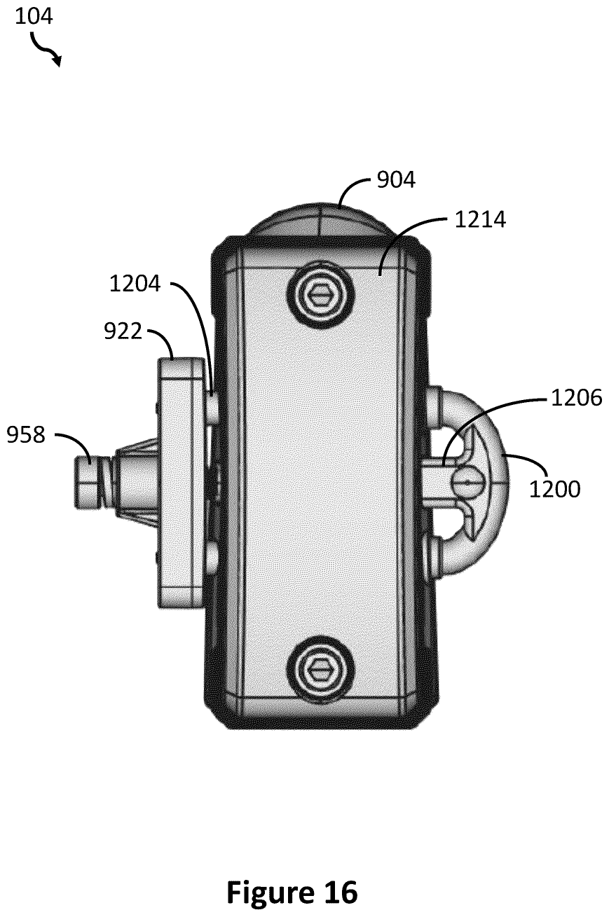

Referring now to FIG. 16, there is shown a bottom view of the mounting bracket 104 with securing key 1200 fully inserted into the mount base 1214. When securing key 1200 is fully inserted into the mount base 1214, the stopper prong 1206 passes into the corresponding receiving opening (not shown) in the mount base 1214 to contact the engagement groove of the inner annular structure (not shown). Additionally, in this fully inserted position the prongs 1204 pass through the mount base 1214 and the securing plate 922 so that the set screw assembly 958 may engage and contact the engagement groove of the inner annular structure (not shown).

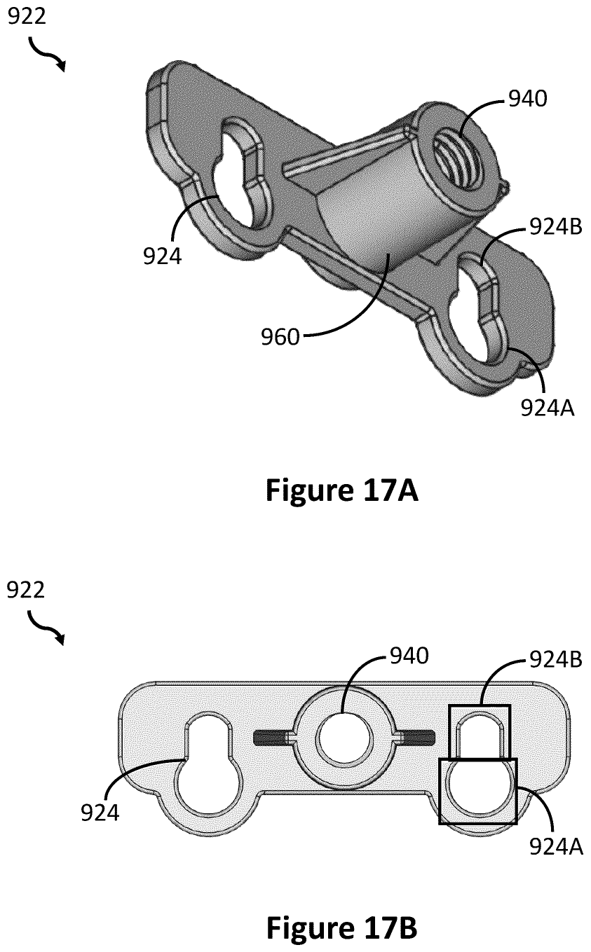

With reference now to FIG. 17A, there is shown an isometric view of the securing plate 922. The view in FIG. 17A shows the wide unlocked portion 924A and the narrow locking portion 924B of the receiving slots 924. Additionally, this view shows the length of the spacing sleeve 960, which surrounds the threaded opening 940 and abuts a head of the set screw (not shown) when fully inserted therein. In the illustrative embodiment, the length of the spacing sleeve 960 corresponds to the length of the set screw assembly 958, so that the head of the set screw 926 abuts the spacing sleeve 960 when the set screw assembly is fully engaged and the stopper screw 930 abuts the inner annular structure 952.

Referring now to FIG. 17B, there is shown a frontal view of the securing plate 922. The view in FIG. 17B shows the wide unlocked portion 924A and the narrow locking portion 924B of the receiving slots 924. In this illustrative embodiment, the narrow locking portion 924B of the receiving slot(s) 924 is oriented above the wide unlocked portion 924A of the receiving slot(s) 924. In this configuration, the securing plate 922 must be shifted from a low locked position to a high open (or unlocked) position so that the wide portion 924A of the receiving slots 924 align with the opening(s) 938 in the base mount 902 and the prongs 916A and 916B of the securing key 916 extending there through and the prongs 916A and 916B of the securing key 916 can pass through the wide unlocked portion 924A of the receiving slots 924. Once the prongs 916A and 916B of the securing key 916 have passed through the wide portion 924A of the receiving slots 924, the securing plate can be lowered into the low locked position where the narrow locking portion 924B of the receiving slots 924 can slot over and/or through the locking groove 936 of each prong 916A, 916B.

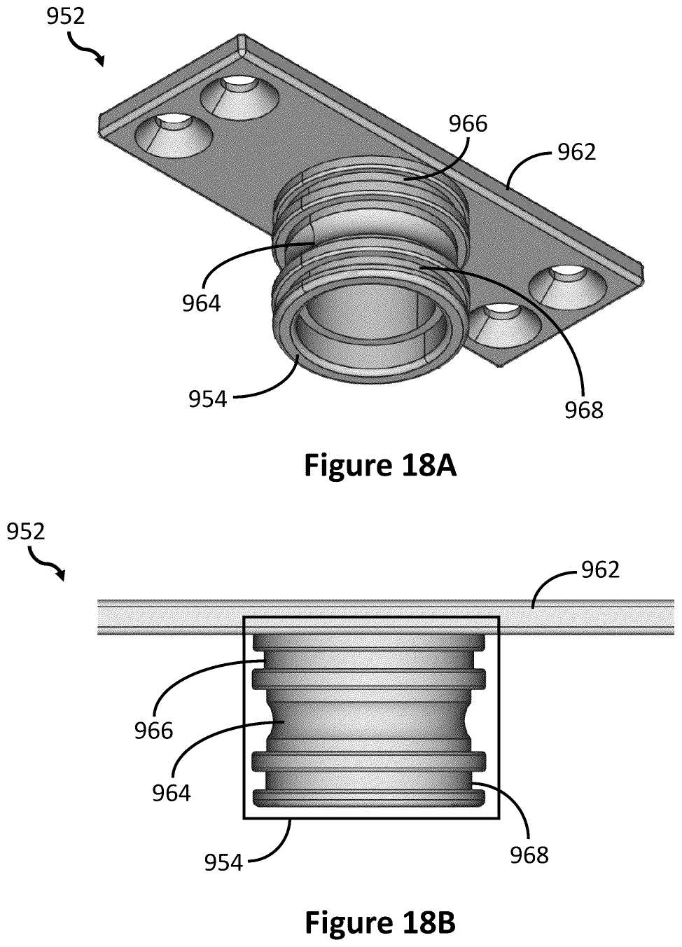

With reference now to FIG. 18A, there is shown an isometric view of the inner annular structure 952 of the clamp 904. In the illustrative embodiment, the inner annular structure 952 includes a base plate 962, a central annulus 954, an engagement groove 964, an upper o-ring groove 966, and a lower o-ring groove 968. The base plate 962 provides a structure with which to couple or affix the inner annular structure 952 to the bottom of the clamp lower portion 910. In some embodiments, the inner annular structure 952 is integral to the clamp lower portion 910 and may not include or require a base plate 962.

The interior of the central annulus 954 forms a cavity through the center of the inner annular structure 952. The exterior of the central annulus 954 is ribbed or ringed to provide horizontal recesses about the circumference of the central annulus 954. In the illustrative embodiment, these recesses form the engagement groove 964, the upper o-ring groove 966, and the lower o-ring groove 968. The engagement groove 964 has a diameter less than the outer diameter of the central annulus 954. The diameter of the engagement groove 964 is also less than the width between the prongs 916A and 916B of the securing key 916, so that the prongs 916A and 916B of the securing key 916 can pass around and/or abut the engagement groove 964. However, the outer diameter of the central annulus 954 is greater than the width between the prongs 916A and 916B of the securing key 916, so that the prongs 916A and 916B of the securing key 916 cannot pass around the outer diameter of the central annulus 954. This configuration of the securing key 916, the outer diameter of the central annulus 954, and the diameter of the engagement groove 964 prevents the inner annular structure from shifting vertically, either up or down, while the securing key 916 is engaged in the base fixture 928 and about the engagement groove 964 of the inner annular structure 952. In the illustrative embodiment, the cylindrical shape of the central annulus 954 enables the inner annular structure 952 to rotate between the prongs 916A and 916B of the securing key 916, and within the outer annular structure 932.

The upper o-ring groove 966 and the lower o-ring groove 968 are configured to receive seals or o-rings formed from rubber, silicon, or a comparable sealant. The orientation of the upper o-ring groove 966 above the engagement groove 964 and the lower o-ring groove 968 below the engagement groove 964 allows o-ring seals placed in the upper o-ring groove 966 and the lower o-ring groove 968 to seal the cavity of the central annulus and any electrical wiring or connector therein or passing there through.

Referring now to FIG. 18B, there is shown a frontal view of the inner annular structure 952 of the clamp 904. The view in FIG. 18B shows the relative sizes of the outer diameter of the central annulus 954 (largest), the diameter of the upper o-ring groove 966 (intermediate), the diameter of the lower o-ring groove 968 (intermediate), and the diameter of the engagement groove 964 (smallest). This view also shows the orthogonal orientation of the central annulus 954 to the base plate 962.

In the illustrative embodiment, the engagement groove 964 is shallow, such that the outer diameter of the central annulus 954 does not extend around or over the full diameter of a securing key prong (not shown) abutting the engagement groove 964. In some embodiments, the engagement groove 964 is deep, such that the outer diameter of the central annulus 954 extends around or over the full diameter of a securing key prong (not shown) abutting the engagement groove 964. Embodiments having a deep engagement groove 964 may be especially useful when the securing key includes only a single prong.

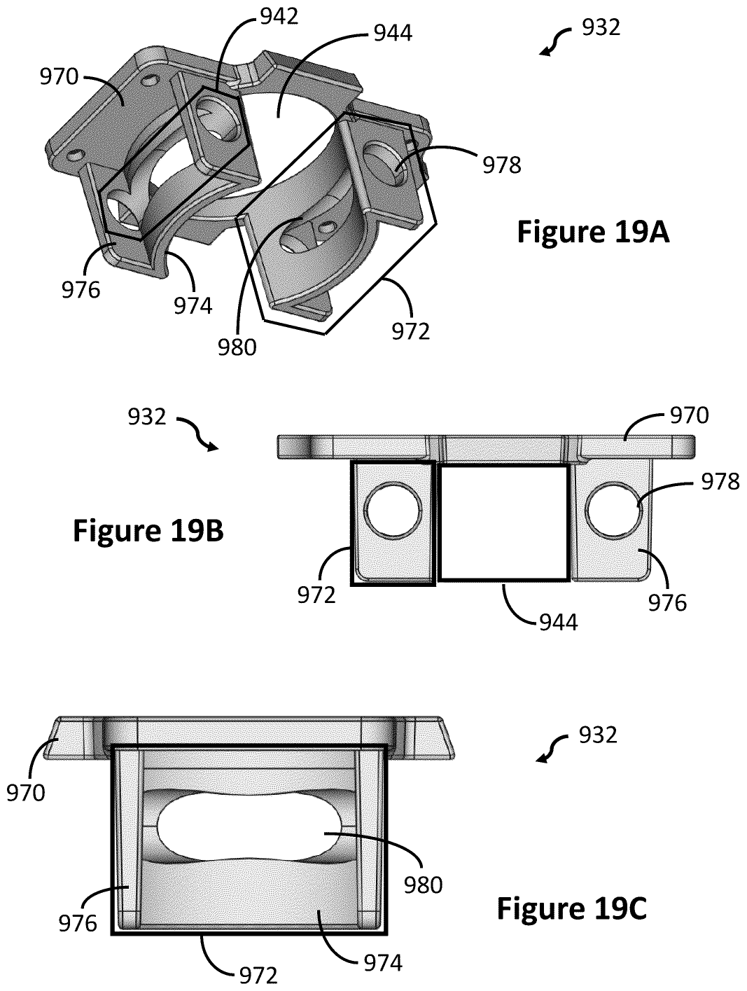

With reference now to FIG. 19A, there is shown an isometric view of the outer annular structure 932 of the base mount 902. The outer annular structure 932 includes a base plate 970, a central annular cavity 944, an annular wall 972 about the central annular cavity 944, and a slot structure 942 passing through the annular wall 972. In the illustrative embodiment, the annular wall 972 is composed of an annular surface 974 and an annular support 976. In the illustrative embodiment, the base plate 970 is oriented horizontally and perpendicular to the central annular cavity 944 and the annular wall 972. The base plate 970 provides a structure with which to couple or affix the outer annular structure 932 to the base fixture 928 of the mount base 902. In some embodiments, the outer annular structure 932 is integral to the mount base 902 and may not include or require a base plate 970.

In the illustrative embodiment, the central annular cavity 944 is only partially delineated and/or surrounded by the annular wall 972, such that gaps exist between annular walls 972 on a first side and a second side opposite the first side of the central annular cavity 944. In some embodiments, the annular surface 974 of the annular wall 972 delineates and surrounds the entirety of the central annular cavity 944. In the illustrative embodiments, the annular surface 974 is curved in correspondence to the cylindrical shape of the central annular cavity 944. In this illustrative embodiment, the annular supports 976 are oriented perpendicular to the length and longitudinal axis of the slot structures 942. The annular supports 976 include slot openings 978 that are each sized and configured to receive one prong 916A or 916B of the securing fork 916 and allow that prong to pass through the slot opening 978. In the illustrative embodiment, each annular wall 972 includes a front and rear annular support 976, which each also include slot openings 978. Thus, in the illustrative embodiment, each annular wall 972 includes a front slot opening 978 and rear slot opening 978. one prong 916A or 916B of the securing fork 916.

The illustrative annular supports 976 abut an annular surface 974 that includes a grooved slot 980, which is sized and configured to receive one prong 916A or 916B of the securing fork 916. In the illustrative embodiment, the prongs 916A and 916B of the securing fork 916 do not pass through the grooved slot 980, but instead run within the grooved slot 980 and along the length of the grooved slot 980. Thus, in operation a prong 916A or 916B of the securing fork 916 passes through a front slot opening 978 of an annular support 976 abutting an annular surface 974, lengthwise within the grooved slot 980 of that annular surface 974, and then passes through the back slot opening 978 of a second annular support 976 abutting that annular surface 974.

This view shows that the slot structure 942 forms a linear, hollow cylindrical path through the front annular support 976, along a portion of the annular surface 974 abutting the front annular support 976, and through the rear annular support 976 abutting that annular surface 974.

Referring now to FIG. 19B, there is shown a frontal view of the outer annular structure 932 of the base mount 902. The view in FIG. 19B shows the gap between one annular wall 972 and a second annular wall 972 that comprises at least a portion of the central annulus 944. Since the slot structure 942 is linear and perpendicular to the plane of the view shown in FIG. 19B, the slot structure 942 is visible only as the slot opening 978 in the front annular support 976.

With reference now to FIG. 19C, there is shown a side view of the outer annular structure 932 of the base mount 902. An annular wall 972 is shown extending downward from the base plate 970, with the annular supports 976 oriented perpendicular to the plane of view. The grooved slot 980 is shown extending along the annular surface 974 and the plane of view. While the grooved slot 980 extends along the annular surface 974, the grooved slot 980 also includes a passage through the annular surface 974 into the annular cavity 944, such that a prong 916A or 916B of a securing fork 916 inserted through the slot structure 942 passes along the grooved slot 980 and a surface of the prong 916A or 916B extends through the passage of the grooved slot 980 into the annular cavity 944 and contacts the engagement groove 964 of an inner annular structure 952 inserted with the outer annular structure 932.

It is to be understood that the detailed description of illustrative embodiments are provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A cage tower speaker mounting system comprising:
an inner annular structure including a central annulus and an engagement groove encircling the central annulus;
an outer annular structure including an annular surface having a grooved slot, wherein the annular surface contours about an outer diameter of the central annulus;
a base mount fixture including at least one passage there through and a receiving opening, wherein the base mount fixture affixed to one of the inner annular structure and the outer annular structure;
a securing plate abutting the base mount fixture, the securing plate including at least one receiving slot, wherein the at least one receiving slot includes a locking portion and an unlocked portion; and
a securing key including at least one prong, a stopper prong, a stopping structure, and a locking groove, wherein the at least one prong extends through the at least one passage and the unlocked portion of the at least one receiving slot, wherein the stopper prong extends into the receiving opening, wherein the stopping structure abuts the base mount fixture, wherein the prong passes along the grooved slot, wherein the prong abuts the engagement groove, wherein the stopper prong abuts the engagement groove, and wherein the locking groove fits within the locking portion of the at least one receiving slot.

2. The cage tower speaker mounting system of claim 1 wherein the outer annular structure includes a second annular surface having a second grooved slot, wherein the second annular surface abuts the outer diameter of the central annulus;
wherein the base mount fixture includes a second passage there through;
wherein the securing plate includes a second receiving slot having a second locking portion and a second unlocked portion;
wherein the securing key includes a second prong having a second stopping structure and a second locking groove, wherein the second prong extends through the second passage and the second unlocked portion of the second receiving slot, wherein the second stopping structure abuts the base mount fixture, wherein the second prong passes along the second grooved slot, wherein the second prong abuts the engagement groove, and wherein the second locking groove fits within the second locking portion of the second receiving slot.

3. The cage tower speaker mounting system of claim 1 wherein the base mount fixture further includes a set screw opening; and
the cage tower speaker mounting system further comprises a set screw assembly including threading along a shaft of the set screw assembly, wherein the threading along the shaft of the set screw assembly engages with complementary threading along an interior of a set hole in the securing plate, and wherein the set screw assembly passes through the set screw hole to abut the engagement groove.

4. The cage tower speaker mounting system of claim 3 wherein the set screw assembly includes a hand-held knob.

5. The cage tower speaker mounting system of claim 1 wherein the annular surface includes at least one annular support having a slot hole through which the at least one prong passes.

6. The cage tower speaker mounting system of claim 1 wherein the stopper prong includes a prong stopper that abuts the engagement groove.

7. The cage tower speaker mounting system of claim 1 wherein the inner annular structure fits within the outer annular structure; and
wherein the inner annular structure rotates within the outer annular structure.

8. The cage tower speaker mounting system of claim 1 wherein the base mount fixture is affixed to a cage tower speaker unit.

9. The cage tower speaker mounting system of claim 1 wherein the outer annular structure is affixed to the base mount fixture; and
wherein the inner annular structure is affixed to a clamp structure.

10. The cage tower speaker mounting system of claim 1 wherein the annular surface of the outer annular structure fully encircles a central annular cavity.

11. The cage tower speaker mounting system of claim 1 further comprising a seal;
wherein the inner annular structure further includes at least one sealing groove encircling the central annulus, wherein the at least one sealing groove receives the at least one seal.

12. A method of operating a cage tower speaker mounting system comprising:
inserting a central annulus of an inner annular structure into a central annular cavity of an outer annular structure, wherein the central annulus of the inner annular structure includes an engagement groove, wherein the central annular cavity of the outer annular structure surrounds the central annulus of the inner annular structure, wherein the outer annular structure includes an annular surface having a grooved slot, wherein the inner annular structure includes an engagement groove encircling the central annulus;
inserting at least one prong of a securing key through at least one passage of a base mount fixture;
inserting the at least one prong of the securing key along the grooved slot of the annular surface;
abutting the engagement groove by the at least one prong of the securing key;
inserting the at least one prong of the securing key through an unlocked portion of at least one receiving slot of a securing plate;
inserting a stopper prong of the securing key through a receiving opening of the base mount fixture;
abutting the engagement groove by the stopper prong of the securing key.

13. The method of claim 12 further comprising:
inserting a second prong of the securing key through a second passage of the base mount fixture;
inserting the second prong of the securing key along a second grooved slot of the annular surface;
abutting the engagement groove by the second prong of the securing key; and
inserting the second prong of the securing key through the second receiving slot of the securing plate.

14. The method of claim 12 further comprising:
inserting a set screw assembly into a set hole of the securing plate, wherein threading along a shaft of the set screw assembly engages with complementary threading along an interior of the set hole in the securing plate;
inserting the set screw assembly into a set screw hole of the base mount fixture; and
abutting the engagement groove with a portion of the set screw assembly.

15. The method of claim 12 further comprising:
inserting the at least one prong of the securing key through a slot hole in at least one annular support, wherein the at least one annular support comprises a portion of the annular surface.

16. The method of claim 12 further comprising:
rotating the central annulus of the inner annular structure within the central annular cavity of the outer annular structure.

17. The method of claim 12 further comprising:
affixing a cage tower speaker unit to the base mount fixture.

18. The method of claim 12 further comprising:
affixing the outer annular structure to the base mount fixture; and
affixing the inner annular structure to a clamp structure.

19. The method of claim 12 further comprising:
sliding a locking portion of the at least one receiving slot on the securing plate onto a locking groove of the at least one prong of the securing key.

20. The method of claim 12 further comprising:
receiving, by at least one sealing groove encircling the central annulus of the inner annular structure, a seal that seals an electrical connector passage through the central annulus.
